(19) United States
(12) Patent Application Publication
(10) Pub. No.: US 2025/0341163 A1
(43) Pub. Date: Nov. 6, 2025

(54) MECHANISMS FOR OPTIMAL OFFSHORE MINERAL MINING

(71) Applicant: MODI VIVENDI AS, Kraakeroey (NO)

(72) Inventor: Gunnar MYHR, Kraakeroey (NO)

(21) Appl. No.: 19/191,807

(22) Filed: Apr. 28, 2025

(30) Foreign Application Priority Data
May 6, 2024 (NO) 20240441

(51) Int. Cl. E21C 50/00; G05D 1/648; G05D 101/15; G05D 103/00; G05D 105/05; G05D 105/80; G05D 107/00; G05D 109/10; G05D 109/30; G05D 111/20; G05D 111/30; G05D 111/50

(52) U.S. Cl. CPC E21C 50/00; G05D 1/648; E21C 2200/00; G05D 2101/15; G05D 2103/00; G05D 2105/05; G05D 2105/80; G05D 2107/27; G05D 2109/10; G05D 2109/38; G05D 2111/20; G05D 2111/30; G05D 2111/56

(57) ABSTRACT

Intelligent algorithms and systems (vehicles and/or mechanisms) locate and extract economic sound concentrations of e.g. any combinations of nodules, manganese crusts and/or sulphide deposit, and separate uneconomic matter from valuable minerals by applying differences in electric and/or acoustic properties to differentiate economically valuable minerals from cost bearing unprofitable other matters (e.g. mud, gravel, rocks, organic matter), thus providing added profitability compared to existing mining machines. Complex and multiple sophisticated technological fields, including, but not limited to Geophysics, Advanced sensor technology (acoustic and electric parameter detection), Signal processing (feature extraction and pattern recognition), Machine learning/AI (classification algorithms and adaptive systems), Mechanical engineering (precision collection mechanisms), Real-time control systems (feedback-based operation), Economic modeling (dynamic threshold determination) are combined. Both independent systems and add-on vehicles to existing mining machines have been developed. Environmental impacts are minimized by the nature of the invented technical solutions. MS and/or AI methods and algorithms can be incorporated.

This invention is related to intelligent systems or vehicles for optimal and economically sound offshore mineral mining operations related to, but not limited to, manganese nodules, manganese crusts and sulphide deposits, based on differences in acoustic and/or electric properties among valuable minerals and non-valuable substances. Both independent vehicles and add-on systems to existing mining machines have been developed to selectively harvest valuable minerals. The developed systems will, by nature, provide added profitability and minimize any environmental impacts. MS and/or AI methods and algorithms can be incorporated as added features.

### 1. INTRODUCTION

All “references”, terms, definitions, and phrases related to all aspects mentioned in the (scientific) references, “Introduction”, “Prior Art”, various “Minerals” and “Invention” sections and in the figures, appendix, also apply to, form the basis of, and are incorporated into the invention represented by this document.

Some general elements like comments and discussions related to e. g. definitions, real time control systems etc. follow, to some degree, what is stated in our previous documents NO345271, NO347777 and NO20231270 (“self-reference”).

The statement “at least one of” means, from a set of variables, activities or processes (synonymous terms) [a₁, a₂, . . . aₙ] either a₁, a₂, . . . or aₙ isolated (single activity) or any combinations among the variables or thereof. The terms, “a”, “one”, “at least one of” and “any combinations of” are synonymous.

“Mechanism”, “system”, “vehicle”, “vessel”, “method”, “non-transitory memory storing” and “machine” are synonymous terms.

“Economic sound concentrations” and “profit level(s)” are synonymous terms.

Machine Leaning (ML) and Artificial Intelligence (AI) are synonymous terms.

“Collector”, separator” and “separation (and collection) mechanism” are synonymous terms. Other definitions are stated in the text to follow.

All electric and/or acoustic data listed in this document for minerals and other matter are stated as examples. Actual numerical data, based on, but not limited to, type and location, can both be higher and lower than the stated examples.

Examples of components, features and/or characteristics, constituting the systems to be developed, are stated throughout in the sections to follow.

The invention integrates complex and multiple sophisticated technological fields, including, but not limited to:
Geophysics,
Advanced sensor technology (acoustic and electric parameter detection),
Signal processing (feature extraction and pattern recognition),
ML/AI (classification algorithms and adaptive systems),
Mechanical engineering (precision collection mechanisms),
Real-time control systems (feedback-based operation),
Economic modeling (dynamic threshold determination).

This inherent technological complexity necessitates analyses and claims to follow, of corresponding sophistication to accurately define the invention's scope. Simplifying beyond a certain point would fail to capture the essential technical characteristics that distinguish this invention from prior art.

To illustrate this point, we note that the European Patent Office (EPO) and/or the USPTO regularly grants patents with complex claims in fields like telecommunications, artificial intelligence, and robotics, where technological complexity demands corresponding claim sophistication. Our claims to follow are comparable in complexity to those found in these advanced technological domains.

### 1.1 Structure and Logic Behind the Invention and the Document/Application

This document is well-organized and carefully designed to defend a sophisticated, multi-domain invention in the field of offshore mineral mining. The logic flows methodically from a technical problem in the real world, through scientific validation, into a detailed technical solution, and finally a legal justification for patentability.

### 1.1.1 Structure

### 1. Contextual Foundation (Sections 1-2)

Purpose: Establishes terminology, real-world necessity, and scope.
Key Move: Anchors the invention in economic and geopolitical needs; scarcity, prices, and offshore mineral abundance.
Importance: It aligns the invention with strategic resource relevance (e.g., batteries, green tech, rare earth elements).

### 2. State of the Art & Gap (Sections 3 and 9)

Purpose: Summarizes prior art systems and explicitly identifies their shortcomings.
Logical Move: Rather than just listing what's missing, it reverse-engineers the “skilled person's” likely direction based on these documents, and shows how a skilled person would not suggest any aspects of this invention.
Strength: Shows that prior art focuses either on mechanical collection or basic detection, not e.g. (economic) selectivity and/or ML/AI-driven decision-making.

### 3. Definition of the Technical Problem (Sections 4 and 9)

Purpose: Sharply formulates (and re-formulates) the “objective technical problem”, and e.g. how to economically and selectively mine valuable seabed minerals.
Key Insight: The invention hinges on the concept of “economic sound concentrations”, a multi-factor variable threshold (e.g. composition, depth, cost, location, market, politics).
Strategic Move: Defines profitability as a dynamic, local, and real-time parameter which is measurable, actionable, and machine-trainable.

### 4. Scientific Justification (Section 5)

Purpose: Proves the physical measurability of mineral properties via acoustic and electric signals.
Logic: If minerals have distinct and measurable acoustic/electric signatures, then it's possible to:
   Detect,
   Classify,
   Make economically informed decisions in real time.
This section also builds the foundation for the ML/AI systems that follow; they need consistent, discriminative input features, which this section provides.

### 5. System Design and Technical Realization (Sections 6-8)

Purpose: Translates the idea into implementable technology.
Three Tiers:
   Sensor systems (acoustic/electric/environmental),
   Real-time decision/control systems, optionally with ML/AI (e.g. deep learning, Q-learning, predictive modeling),
   Collection systems, e.g. robots, claws, suction, mechanical separation.
Strategic Duality:
Describes both stand-alone vehicles and add-on pathfinders/systems for legacy mining machines.
This makes the invention applicable to both greenfield and brownfield projects.

### 6. Algorithmic Enablement (Section 6.3)

Purpose: Demonstrates that the idea is not just conceptual, e.g. it can be coded.
Logic: Provides e.g. a high-level algorithm and pseudocode in Python.
Satisfies enablement and adds weight to the claim of inventiveness and implementability.

### 7. Hardware Realization (Section 7)

Purpose: Maps the software and algorithms into physical components.
Logic: Lists real-world electromechanical components (e.g. robotic arms, sonar, sensors, connectors).
Strategic Defense: Supports claims of novelty, inventive step and industrial applicability.
   8. Integration with Existing Systems (Section 8)
Purpose: Provides retrofitability.
Logic: Pathfinders/other systems can be attached to prior art vehicles, thus expanding the usage domain.
Legal Defense: Demonstrates that the invention is not just a novel and inventive device, but a new capability.

### 9. Legal Argumentation and Inventive Step Defense (Section 9)

Purpose: Rigorously re-compares the invention to the closest prior art (e.g., D1, D2).
Logic: Uses EPO's problem-solution approach:
   Identifies technical differences and shortcomings.
   Re-formulates the objective problem.
   State that the skilled person would not suggest any aspects of the invention.
   Demonstrates synergy between systems (sensors+ML/AI+mechanical separation+economic logic).
Strong move: Emphasizes that combining prior art would require hindsight, thus violating EPO/USPTO rules.

### 1.1.2 Logic

This invention is more than (a) machine(s). It is a closed-loop, intelligent mineral mining ecosystem. The workings of the internal logic of the invention:

1. Starts with Selectivity
Most existing systems grab or suck indiscriminately from the seabed.
Which is energy-intensive, environmentally damaging, and uneconomic.

### 2. Minerals Have Signatures

Minerals reflect or conduct energy (acoustic/electric) differently.
These signatures can be measured and learned.

### 3. Selectivity can be Automated

A system can learn what would be profitable and selectively harvested.
A (developed) machine can decide in real time whether a deposit is economically worth collecting.

### 4. Economics is not Static

Profitability varies with:
   Location, depth, market price, mineral content, political risk, etc.
Therefore, a “threshold” must be dynamic.
The system can learn and adapt.

### 5. The System is Modular and Scalable

Can be applied to:
   New autonomous vehicles.
   Retrofitted to legacy mining equipment.
Works across varying seabed conditions and mineral types.

### 6. ML/AI is a Tool, not a Requirement

The system is functional with rule-based control.
ML/AI is an “added feature”, not a dependency, thus making the invention broader.

### 7. Legal Logic: Problem-Solution-Enablement

Defines the technical problem clearly.
Proves that prior art does not teach or suggest any aspects of the invention.
Provides implementation detail (physics+code+hardware).
Justifies novelty, non-obviousness and inventive step with precision.

### 1.1.3 Remarks

The document is architected to support patentability through:
Deep technical grounding (e.g. sensor physics, signal processing),
Clear logical progression from problem to solution,
Legal robustness (alignment with e.g. the EPO problem-solution methodology),
Real-world feasibility (e.g. pseudocode, mechanical systems, operational logic).

The invention itself solves a pressing environmental, economic, and engineering challenge in a way that no known system can, by integrating e.g. sensor physics, intelligent algorithms, and mechanical selectivity into one cohesive system.

### 2. OFFSHORE MINERALS IN DEEP OCEANS—GENERAL REMARKS

Due to general scarcity, increasing prices and politically unfavorable locations of valuable minerals (e.g. Russia or China), constitute to the interest and focus for offshore mining of manganese crusts, nodules and/or sulphide deposits located on the seabed. In general manganese or ferromanganese nodules and/or crusts, typically consist of various minerals, including manganese oxides, iron oxides, and other trace elements. The mineral composition can vary depending on factors such as e.g. the location, depth, and geological conditions. E.g. manganese crusts are primarily composed of manganese oxides, which can range from 20% to 70% of the crust's composition. Iron oxides are another significant component, usually ranging from 10% to 30%. Other trace elements, manganese crusts may also contain smaller percentages of other elements such as nickel, copper, cobalt, and rare earth elements (REEs), among others. These trace elements can collectively make up around 1% to 10% of the crust's or nodule's composition or sulphide deposits.

For general scientific references, some reputable sources could include International Marine Minerals Society (IMMS), Geological Society of America (GSA), American Geophysical Union (AGU), Deep Sea Minerals (DSM) Observatory. See relevant websites for further details.

### 2.1 Mineral Deposits—Norwegian Offshore Deep Seas—General Remarks

The Norwegian Offshore Directorate's expedition to the Mohns Ridge in the Norwegian Sea has identified a large area of e.g. sulphide minerals. The minerals are precipitated through “black smokers” on the seabed, where seawater heated by underlying magma chambers dissolves many minerals and then flushes them back out to the seabed.

Marine geoscience research indicates that the exploration and extraction of these seafloor massive sulphide (SMS) deposits could potentially yield a commercial resource base of millions of tons of copper, zinc, and cobalt, with copper being the most significant part of the findings. The economic potential of these deposits is substantial.

The typical mineral composition of manganese crusts in the Norwegian offshore deep seas primarily consists of manganese and iron, with smaller amounts of other metals such as cobalt, nickel, copper, lithium, scandium, and various REEs. These crusts were formed by precipitation from seawater and accumulate on underwater rock formations in the deep sea.

A detailed breakdown of the mineral compositions and their respective percentages for manganese crusts in the Norwegian offshore deep seas, as reported by the Norwegian Offshore Directorate and related marine geoscience research:
Manganese (Mn): Predominant element,
Iron (Fe): Second most abundant element,
Cobalt (Co): Smaller amounts, significant for economic value,
Nickel (Ni) and Copper (Cu): Present in trace amounts,
Lithium (Li), Scandium (Sc), and REEs occur in minor concentrations.

The exact percentages can vary, but typically, manganese crusts are composed of approximately 15-30% manganese and 5-15% iron. Cobalt, nickel, and copper usually constitute less than 1% each, while lithium, scandium, and REEs are found in even smaller quantities.

The typical mineral compositions for sulphide deposits in the Norwegian offshore deep seas, particularly in areas like the mid-Atlantic Ridge between Jan Mayen and Svalbard, are as follows:
Copper (Cu): Up to 14% in some samples,
Zinc (Zn): Approximately 3%,
Cobalt (Co): Less than 1%.

These deposits may also contain significant amounts of other minerals, including manganese, magnesium, vanadium, titanium, and various REEs minerals. The presence of these minerals is crucial for technologies such as batteries, wind turbines, PCs, and mobile phones.

General documentation for mineral compositions in Norwegian offshore deep seas can be obtained in e.g.: https://www.sodir.no/en/facts/seabed-minerals/manganese-crusts/and_https://maritime-executive.com/article/norway-discovers-seabed-mineral-deposits-in-norwegian-sea.

### 3. PRIOR ART

WO2018068362A1 Describes a deep-sea mining system that includes a transport ship, an undersea self-propelled floating body, a seabed mobile delivery station, and a seabed mineral collection machine. The system uses flexible hoses to connect these components, allowing for the collection and transportation of minerals from the seabed to the ship. The design aims to simplify the structure and enable large-scale use.

US20230074267A1 Outlines a deep-sea mining vehicle designed to collect mineral deposits from the seabed and transport them to a floating device. The vehicle features a support frame with movement capabilities, a storage for collected minerals, and a suction head with a pressure chamber to facilitate the collection process. The vehicle is particularly suited for collecting polymetallic nodules like manganese nodules.

TechnipFMC, Wilhelmsen and NorSea are investing in deep-sea mining.

The stated article discusses the investment by TechnipFMC, Wilhelmsen, and NorSea in Loke Marine Minerals. They are developing a patent-pending autonomous subsea production system designed to presumably have minimal environmental impact. The system aims to enable efficient deep-sea mining operations. https://www.offshore-energy.biz/technipfmc-wilhelmsen-norsea-investing-in-deep-sea-mining/.

In addition to the above stated prior art, the below listed documents 1-5 may have some relevance. Given the objective technical problem to be solved;
how to optimize the collection of valuable seabed minerals by distinguishing economically viable deposits from uneconomic material using real-time decision-making, based on acoustic and/or electric properties (sensor data), the question would be how would a skilled person with knowledge of 1-5, might attempt to solve the problem?

1 (CN112282761A) Focuses on detecting manganese nodules on the seabed using sensors. The skilled person might start by refining the detection process, improving the accuracy of identifying mineral deposits using these sensors. However, e.g. 1 does not suggest or teach any method for making economic decisions about the profitability of the deposits.
Likely approach: The skilled person would likely attempt to optimize the sensor system to better distinguish nodules from non-nodules (mud, gravel, etc.). However, without guidance on economic analysis or focus on intelligent optimization, the skilled person would rely solely on detection, not on evaluating profitability.

2 (KR20170127836A) Discusses the use of a robotic mining system for collecting manganese nodules, but the focus is on the mechanical aspects of the mining process. There is e.g. no mention of real-time analysis or applying any economic thresholds.
Likely approach: The skilled person might combine the mechanical systems of 2 with the detection systems of 1 to collect detected mineral deposits. However, the skilled person would not address the economic viability of the deposits or use any intelligent system to differentiate between profitable and unprofitable deposits.

3 (CN115879648B) Focuses on detecting manganese nodules using sensors, similar to 1, and e.g. does not address economic analysis or intelligent systems for decision-making.
Likely approach: The skilled person might look at 3 as reinforcing the detection methods described in 1. The emphasis would still be on detecting and locating mineral deposits, with no further optimization based on profitability.

4 (Feng Hong et al., «Minerals», 2022, 12) Discusses using deep learning techniques to classify seabed materials using acoustic probes. While this document introduces machine learning, it e.g. does not apply this technique to evaluate the economic viability of deposits or guide the collection of economically valuable material.
Likely approach: The skilled person might be inspired to use deep learning techniques to improve the classification of detected deposits. However, 4 does not teach using this classification for real-time economic decision-making, nor does it suggest how to optimize the collection process based on profitability.

5 (Umesh Neettiyath et al., “IEEE Jornal of Oceanic Engineering, 46 (1) Covers a robotic survey system that uses machine learning to estimate the distribution of manganese crusts. While it touches on machine learning, it e.g. does not suggest applying this technology for economic optimization or real-time selective extraction.
Likely approach: The skilled person might apply machine learning to improve the spatial accuracy of detecting minerals, but they would not be led to incorporate economic thresholds or adaptive learning for profitability assessment.

E.g. the EPO Guidelines for Examination (G-VII, 5.1) explicitly state that an inventive step assessment should involve only the “most relevant” prior art (i.e., the closest prior art) and further documents may be combined if the skilled person would be motivated to do so. However, combining more than two documents is generally discouraged unless there is a clear, simple, and obvious motivation for such a combination. Combining too many documents would lead to an unjustifiable complexity and would conflict the principles of the problem-solution approach. The EPO guidelines (G-VII, 8) strongly caution against the use of hindsight when combining documents to assess inventive step. Hindsight means that a person skilled in the art is able to combine prior art references only because they already know the claimed invention. In the problem-solution approach, the documents should naturally combine without knowledge of the invention, and the solution should be obvious at the time of filing.

Using the problem-solution approach, it is clear that a skilled person in the art, with knowledge of 1-5 but not of NO20240441 and this document, would likely focus on improving detection and mechanical collection techniques. However, they would fail to solve the objective technical problem as defined in NO20240441 and this document, therefore, the solutions provided represent non-obvious inventive step over the prior art.

### 4. INVENTION

Challenges related to offshore mining are to locate economic sound concentrations, with relevant economic valuable mineral compositions, based on any combinations, but not limited to, of nodules, manganese crusts and/or sulphide deposits. Also, current mining techniques add e.g. the absorption or extraction of mud, gravel, rock and/or other uneconomic matter when extracting presumable valuable minerals from the seabed. These non-economic types of matter need pumping power, can degrade equipment, can be elevated several 1000 m from the seabed to the surface, require top-side separation, thus adding significant costs to offshore mining operations.

The overall objective technical problem to be solved by the invention, is the development of intelligent systems to, but not limited to, locate and partially or fully extract economic sound concentrations of any combinations of nodules, manganese crusts and/or sulphide deposit, thus select and separate uneconomic matter from valuable minerals. Emphases are made on applying differences in electric and/or acoustic properties to differentiate economically valuable minerals or concentrations of minerals from cost bearing unprofitable other matter (e.g. mud, gravel, rocks, organic matter). Some debris (non-valuable matter) is expected to be extracted, thus the term “fully” (100%) is a target.

Both stand-alone vehicles and add-on systems to existing harvesting machines (see e.g. section 3) are to be developed.

MS and/or AI methods and algorithms can be added to the systems or vehicles.

### 4.1 The Concept of Economic Sound Concentrations

a. The density of any combinations of nodules, manganese crusts and/or sulphide deposit can vary on the seabed. It can be measured as numbers and/or weight (kg) per area (m²).

b. The mixture or composition of valuable minerals can vary as a function of area.

c. The concentration of various valuable minerals within e.g. nodules, manganese crusts and/or sulphide deposit vs un-valuable matter can vary (%).

d. Location can be a cost issue (e.g. distance to shore and general weather conditions can represent added cost elements).

e. Depth can be a cost issue.

f. Seabed topography can complicate operations and can represent an added cost element.

g. Commodity prices can vary.

h. Politics. Changing or different political governments and/or attitudes towards offshore mining can change.

i. Definition of profits and/or rate of return(s) and/or interest rates can vary.

j. Real extraction rate (%).

The listing a-j are examples of considerations or variables which will define the concept of “economic sound concentrations”. The concept “economic sound concentrations” will vary with location and time. A certain level of “economic sound concentrations” or “profit level(s)” will define a “threshold” or a targeted profitable value (or number). A “number” can be gross profits/week in USD, based on type of mineral (tons) multiplied by the commodity price for the specific mineral, and summarize for all the minerals in question. Such a “number” can (also) be represented by a probability, with or without any combinations of e.g., but not limited to, any combinations of the elements represented by the listing a-i or a-j. The real extraction rate (j) is particularly dependent on the density (a), composition of valuable minerals (b) and concentrations of various valuable minerals (c), related to the degree of selective harvesting. “Fully” extraction or 100% selectivity, in the meaning that no non-valuable matter is to be harvested, is a target. In practical offshore mining operations, some debris (non-valuable matter) is (also) expected to be extracted. In some circumstances the real extraction rate (j) can be purposefully defined or set by the user as a number other than (below) 100%, depending on factors a-i. This if a lower extraction rate can maximize profits, based on local conditions. The concept “threshold” is a variable. Certain offshore mining operations which fulfill a threshold at one point in time can be terminated, temporarily or permanently, if the threshold is believed not to be reached.

### 5. SCIENTIFIC BASIS FOR THE INVENTION

We emphasize throughout this document that local concentrations of valuable minerals and non-valuable substances have to be analyzed with respect to acoustic and/or electric properties. The outlined (general) remarks to follow, have to be considered as guidelines in the search for optimized solutions or profit levels or the obtaining of threshold level(s).

### 5.1 Electric Properties for Minerals

The typical electrical parameters for differentiating minerals include, but are not limited to, electrical conductivity, resistivity, and dielectric properties. These parameters can vary widely depending on, but not limited to, the type of mineral, its purity, and environmental conditions such as salinity, temperature and pressure.

For instance, the electrical conductivity of minerals is influenced by the presence of free ions and the mobility of these ions within the mineral structure in question. Minerals with high ionic content, like halite (NaCl), typically have higher conductivity. In contrast, minerals with covalent or metallic bonding, like quartz or gold, exhibit different electrical behaviors.

Resistivity is another crucial parameter, which is the inverse of conductivity. It measures how strongly a mineral opposes the flow of electric current. This property is particularly important in geophysical exploration for deposits. Additionally, dielectric properties determine how a mineral responds to an electric field and are related to the mineral's ability to store electrical energy.

Electrical Conductivity: This can vary widely from 10⁻² to 10⁷ S/m. For example, metallic minerals like native copper can have very high conductivity, while minerals with covalent bonds like quartz have much lower values.

Resistivity: Common rock types can have resistivity values ranging from 10² to 10⁸ ohm-m. Sulfide minerals, which often have partially metallic bonds, tend to have lower resistivity.

Dielectric Constant: This is typically in the range of 2 to 200 for most minerals. It's a measure of a mineral's insulating ability.

These are general ranges and have to be treated as examples. Specific minerals can have values that fall outside these ranges under certain conditions, e.g. dependent on location, depth, etc.

### 5.1.2 Electric Properties for Sulphide Deposits

The typical electrical parameters for offshore sulphide deposits, such as SMS (Seafloor Massive Sulphide), are characterized by their distinct electrical properties compared to unmineralized host rocks. These properties are crucial for exploration and resource evaluation, as they also can be used to detect SMS deposits during drilling operations, potentially reducing costs and accelerating offshore activities.

Some examples of electrical properties based on scientific research:

Frequency-Dependent Complex Electrical Resistivity: SMS deposits exhibit frequency-dependent complex electrical resistivity in the range between 0.002 and 100 Hz. This property can potentially discriminate between different types of fresh rocks, alterations, and mineralizations.

Resistivity Magnitude: The resistivity magnitude alone, with appropriate electrical sensors, can distinguish between mineralized and non-mineralized samples. Exploiting the frequency-dependent behavior of resistivity might amplify the differences and further improve rock characterization.

Self-Potential and Magnetic Susceptibility: These parameters differ distinctly between sulfides and the host rocks and sediments, which is beneficial for prospecting SMS deposits.

### 5.2 Acoustic Parameters for Minerals

Acoustic parameters for minerals are essential for understanding their behavior under various conditions. Some key parameters and references, but not limited to;

Centroid frequency (Fcf) and transmission coefficient (Tcf): These parameters are generally positively correlated with grain uniformity in rocks. The mineral grain size impacts these parameters differently in igneous and sedimentary rocks.

Ultrasonic characteristics (Vp, Fcf, Tcf) and damage characteristics (D3): These are significantly influenced by the main mineral compositions such as quartz, plagioclase, and k-feldspar.

Longitudinal velocity (Vp): This correlates with the density and mean atomic weight of rocks. It can be estimated from modified Hashin-Shtrikman bounds for rocks with similar mean atomic weight.

Sound velocity: For minerals, the longitudinal sound velocity typically ranges from 4,000 to 7,000 m/s. This parameter is crucial for understanding the elastic properties of minerals and can vary depending on the mineral composition and structure.

Acoustic impedance (Z): This parameter is defined as the product of the density of the material and the sound velocity through it. For most minerals, acoustic impedance can range from 15 to 30 MRayl (mega ray-leighs).

Porosity: In porous minerals, porosity can significantly affect acoustic properties. The porosity percentage can vary widely, from less than 1% to over 30%, depending on the type of mineral and its formation process.

These parameters and values are examples. Other parameters can be applied depending on local conditions. In this context “sound” and “velocity” are synonymous terms.

### 5.2.1 Acoustic Parameters for Offshore Sulphide Deposits

Acoustic parameters for offshore sulphide deposits are crucial for exploration and resource evaluation. Here are some typical parameters;

Sound Velocity (Vp): The sound velocity in sulphide deposits can vary significantly, but it generally ranges from 1,500 to 6,000 m/s depending on the composition and porosity of the deposit.

Density (p): The density of sulphide deposits is typically higher than that of the surrounding water and sediments, ranging from 3,000 to 5,000 kg/m³.

Acoustic Impedance (Z): This is calculated by multiplying the density (p) by the sound velocity (Vp) and can range from 5 MRayl to 30 MRayl.
Attenuation (a): Attenuation rates can be high in sulphide deposits due to the complex structure and can range from 0.1 to 2 dB/m.

These parameters and values are examples. Other parameters can also be applied dependent on local conditions.

5.2.2 Acoustic Properties of Offshore Manganese Crusts and/or Nodules

Offshore manganese crusts, known for their cobalt-rich composition, have distinct acoustic properties that are key for exploration and resource assessment. Some typical acoustic parameters for crusts:

Sound velocity (Vp): The velocity of sound through manganese crusts can vary, but it typically ranges from 1,500 to 6,000 m/s.

Density (p): Manganese crusts have a higher density than seawater, generally ranging from 2,000 to 3,000 kg/m³.

Acoustic Impedance (Z): Typical values for manganese crusts ranging from 10 MRayl to 18 MRayl.

Attenuation (a): The attenuation of sound in manganese crusts can be significant due to their structure, with values ranging, but not limited to, from 0.1 to 1 dB/m.

These parameters and values are examples. Other parameters can also be applied depending on local conditions.

Understanding the electrical and acoustic properties of minerals and geological deposits is essential for geophysical exploration and resource assessment related to economically sound, optimal and intelligent offshore mineral mining. Below is a summary of some of these properties, including numerical values where available, along with detailed references specifying the source documents and page numbers.

5.3 Further Comments with Specific Scientific References

### 5.3.1 Electrical Properties

Sulfide Minerals: Sulfide ores or deposits, such as those containing nickel (Ni), copper (Cu), and Platinum Group Elements (PGE), exhibit high electrical conductivity due to the metallic nature of their bonding. These minerals are strongly anomalous in electrical conductivity compared to their host rocks.

Source: King, A. (2007). Review of Geophysical Technology for Ni—Cu-PGE deposits. Proceedings of Exploration 07: Fifth Decennial International Conference on Mineral Exploration, 647-665.

Seafloor Massive Sulfides (SMS): SMS deposits are characterized by distinct electrical properties compared to unmineralized host rocks. The presence of conductive sulfide minerals significantly influences the electrical conductivity of these deposits.

Source: Spagnoli, G., Hannington, M., Bairlein, K., Hördt, A., Jegen, M., Petersen, S., & Laurila, T. (2016). Electrical properties of seafloor massive sulfides. Geo-Marine Letters, 36, 235-245.

Offshore Manganese Crusts and Nodules: Manganese nodules and crusts are known to have specific electrical properties that can be detected using geophysical methods. These properties are influenced by their mineral composition and the surrounding environment.

Source: Hein, J. R., Mizell, K., Koschinsky, A., & Conrad, T. A. (2013). Deep-Ocean Mineral Deposits as a Source of Critical Metals for High- and Green-Technology Applications: Comparison with Land-Based Resources. Ore Geology Reviews, 51, 1-14. Available at Academia.edu.

### 5.3.2 Acoustic Properties

Sulfide Minerals: Sulfide ores exhibit distinct acoustic velocities, which can be utilized in geophysical surveys to detect and characterize these deposits.

Source: King, A. (2007). Review of Geophysical Technology for Ni—Cu-PGE deposits. Proceedings of Exploration 07: Fifth Decennial International Conference on Mineral Exploration, 647-665.

Offshore Sulphide Deposits: The acoustic properties of seafloor massive sulfide deposits are influenced by their mineral composition and porosity. Understanding these properties is crucial for interpreting sub-seafloor images from geophysical surveys.

Source: Ohta, Y., Goto, T., Koike, K., Kashiwaya, K., Lin, W., Tadai, O., Kasaya, T., Kanamatsu, T., & Machiyama, H. (2024). Correlation between induced polarization and sulfide content of rock samples obtained from seafloor hydrothermal mounds in the Okinawa Trough, Japan. Earth, Planets and Space, 76, Article number: 54.

Offshore Manganese Crusts and Nodules: The acoustic properties of manganese nodules and crusts are essential for their detection and assessment. Recent studies have demonstrated the use of parametric acoustic probes in recognizing manganese crusts.

Source: Li, J., Li, X., & Zhang, W. (2022). First Demonstration of Recognition of Manganese Crust by Deep-Sea Parametric Acoustic Probe. Minerals, 12 (2), 249.

Hein, J. R., Mizell, K., Koschinsky, A., & Conrad, T. A. (2013). Deep-Ocean Mineral Deposits as a Source of Critical Metals for High- and Green-Technology Applications: Comparison with Land-Based Resources. Ore Geology Reviews, 51, 1-14. Available at Academia.edu.

### 6. PRIMARY COMPONENTS AND FEATURES CONSTITUTING THE INVENTION

This section follows to some degree the (self) references stated in the “Introduction” chapter related to e.g. sensors and control and guidance system. Section 6 represents primary components, features and characteristics of the invention, to be developed in sections 7 and 8.

A system is a group of interacting or interrelated elements or components (synonymous) that act or are interconnected according to a set of rules, features (synonymous terms) or mechanisms to form a unified whole. A system is surrounded by its boundaries.

### 6.1 Sensors

Besides the at least one electronic and/or acoustic sensor, the at least one sensor incorporated in any of the systems and/or elements within a system constituting this invention can, but are not limited to, detect (quality and quantity) pressure, temperature, heat (infrared), velocities, frequencies (sound, light), stress, strain, movements, motion, represent cameras, low light cameras, infrared cameras, GPS trackers, telephones, Internet of Things (IoT), satellite communications. Such sensors can be, but are not limited to, analog or digital electronic, electro-mechanical, optical or of any sound or ultrasound types. The at least one sensor can be connected by at least one wire or wireless communication unit or device, but not necessarily.

### 6.2 Real-Time Control and Guidance Systems (RTCGS)

The at least one data processing unit, within the invention or systems to be developed, will include real-time control, which requires controllers to capture all the significant target activities and to deliver their responses as swiftly as possible so that system performance is never degraded.

In Advanced Industrial Control Technology, Peng Zhang, 2010, ISBN: 978-1-4377-7807-6, https://www.sciencedirect.com/book/9781437778076/advanced-industrial-control-technology #book-info, structure and requirements to real-time control systems are outlined, excerpts (chapter 1.2.1, line 7):
“A control operation is a series of events or actions occurring within system hardware and software to give a specific result. A real-time control system is a system in which the correctness of a result depends not only on its logical correctness but also on the time interval in which the result is made available. The following three standards give the definition of a real-time control operation, and an industrial control system in which all the control operations occur in real-time qualifies as a real-time control system:
(1) Reliable operation execution—the operation execution must be stable, and it must be repeatable.
(2) Determined operation deadline—any control operation needs time to execute.
(3) Predictable operation result—the result for any control operation must be predictable.”

Based on e.g. combinations of, but not limited to, Model Predictive Control, (MPC), Proportional Integral Derivative (PID), Deep Reinforcement Learning (DRL), three characteristics of ML/AI-based controllers can be utilized, if ML/AI capabilities are to be applied as added features;
1. Learning: DRL-based controllers learn by methodically and continuously practicing ML.
2. Delayed gratification: DRL-based controllers can learn to recognize sub-optimal behavior in the short term, which enables the optimization of gains in the long term.
3. Non-traditional input data: DRL-based controllers manage the intake and are able evaluate sensor information that automated systems cannot.

The enablement of e.g. DRL-based control systems to a process facility, require, but are not limited to, the following steps in delivering a DRL-based controls:
1. Preparation of a companion simulation model for the (AI) brain,
2. Design and training of the (AI) brain,
3. Assessment of the trained (AI) brain,
4. Deployment.

It is to be emphasized that applications of any combinations of MPC, PID or DRL do not require ML/AI models.

### 6.2.1 ML/AI can be Incorporated as Added Features

In this context the ML/AI brain(s), as features within the at least one data processing unit is/are, but not limited to, to be trained to, at least one of; foresee, forecast, predict, simulate, optimize or otherwise.

Aid in offshore mining for e.g. manganese crusts, nodules, and sulphide deposits by enhancing exploration, extraction, and processing activities can be advantageous. Some ways ML/AI can contribute to this field can be, but are not limited to:
Exploration: AI can analyze geological data to predict the location of mineral deposits with greater accuracy. ML/AIlearning algorithms can process vast amounts of seismic and subsea data to identify patterns, but not limited to, that may indicate the presence of e.g. manganese crusts or nodules or sulphide deposits.
Extraction: ML/AI-driven autonomous underwater vehicles (AUVs) and remotely operated vehicles (ROVs) can be used for the precise and efficient collection of mineral deposits. These vehicles can navigate challenging underwater terrain and perform tasks with minimal human intervention.
Processing: ML/AI can optimize the processing of collected minerals by predicting the quality of mineral deposits and suggesting the most efficient processing methods. This can lead to a reduction in energy consumption and an increase in yield.
Environmental Monitoring: ML/AI can help monitor the environmental impact of mining activities by analyzing data from various sensors in real-time. This allows for immediate adjustments to minimize ecological disruption.
Safety: ML/AI can enhance the safety of offshore mining operations by predicting equipment failures and potential hazards.

Overall ML/AI has the potential to make offshore mining for manganese crusts, nodules, and sulphide deposits more efficient, safer, and environmentally friendly.

### 6.2.1.1 Development of ML/AI Components to Fulfill the Requirements for “Systems for Optimal Offshore Mineral Mining”—if Applied

To effectively control the provided optimal mineral mining system, with priority from NO20240441, multiple integrated AI systems work together to enable intelligent decision-making, efficient resource collection, and environmental protection. At the core, sensory systems process acoustic and electrical data to identify valuable mineral deposits, while a Deep Q-Learning agent makes high-level navigation and collection strategy decisions. These systems are supported by a comprehensive mapping and data collection framework that maintains historical information and helps optimize future operations.

The AI components are initially trained in simulation environments that model seabed physics and sensor responses, allowing for safe development and testing before deployment. As the system operates in real conditions, it continuously learns and improves through self-correction mechanisms, adapting to new scenarios and optimizing its performance based on actual operational data.

Each component is designed with fallback systems and safety protocols, ensuring reliable operation even in challenging deep-sea conditions. The integration between these systems is carefully orchestrated to maintain real-time processing capabilities while meeting the economic and environmental requirements specified in the patent.

This specification details each component's functionality, their interactions, and how they collectively achieve the provided document's objectives of efficient, environmentally conscious offshore mineral mining.

The provided components represent examples. The template is fully in compliance with EPO decisions T0161/18 and T1069/21. Other components and sub-systems and/or models can be applied.

A thorough assessment of primary components and steps within a suggested ML/AI system is provided in the appendix, which represents an integral part of this document.

### Excerpts;

### 1. Simulation System

A comprehensive simulation environment is required to develop and validate the AI systems before real-world deployment. This environment serves multiple purposes: training the DQL navigation agent, testing sensor processing algorithms, and generating synthetic training data for the classification systems. The simulation must accurately model the complex dynamics of deep-sea operations while remaining computationally efficient enough for rapid training iterations. It could further comprise:

### 1.1 Physics Modeling

The simulation incorporates key physical aspects of the deep-sea environment:

### 1.2 Sensor Response Simulation

Accurate modeling of sensor responses is crucial for developing robust detection algorithms:

### 1.3 Environmental Variations

The simulation includes dynamic environmental conditions to ensure system robustness:

### 1.4 Mineral Deposit Scenarios

A variety of test scenarios are implemented to validate system performance:

### 1.5 Training Data Generation

The simulation environment serves as a primary source of synthetic training data, generating extensive datasets for training both the sensory prediction systems and the DQL agent:
1.5.1 Large-scale Synthetic Dataset Creation
1.5.2 Data Augmentation and Variation
1.5.3 Ground Truth Labeling
1.5.4 Validation Framework

This comprehensive data generation system ensures that the AI components have sufficient training data to develop robust and accurate prediction capabilities before real-world deployment, while the validation framework provides quantitative metrics for system performance assessment.

### 2. Mapping and Data Collection System

The mapping and data collection system serves as the foundational layer for all other AI components, maintaining a comprehensive understanding of the operational environment and historical data. This system continuously updates a 3D representation of the seabed while storing and organizing all sensor readings and operational outcomes. It could further comprise:
2.1 Real-time 3D Mapping
2.2 Data Storage and Organization
2.3 Mineral Deposit Tracking
2.4 Environmental Monitoring
2.5 Integration with Decision Systems

This system not only maintains the operational knowledge base but also provides crucial input for the DQL agent's decision-making process and enables continuous improvement of the prediction systems through comprehensive performance tracking.

### 3. Sensor Data Processing System

The sensor data processing system handles the raw acoustic and electrical sensor inputs, processes them to extract meaningful features, and evolves over time through the incorporation of deep learning models trained on operational data. This hybrid approach ensures reliable baseline performance while enabling continuous improvement through learning. It could further comprise:
3.1 Traditional Signal Processing Pipeline
3.2 Deep Learning Enhancement
3.3 Sensor Fusion
3.4 Performance Monitoring
3.5 Integration Points

### 4. DQL Navigation and Decision Agent

The Deep Q-Learning Navigation and Decision Agent serves as the primary decision-maker for the system, optimizing exploration, scanning, and collection strategies to maximize economic return while minimizing environmental impact. This agent operates continuously in a complex state space, making both strategic and tactical decisions about system operation. It could further comprise:
4.1 State Space Definition
4.2 Action Space
4.3 Reward Function Design
4.4 Training and Optimization
4.5 Performance Monitoring

### 5. Classification and Prediction System

The Classification & Prediction System processes the sensor data to identify mineral deposits, predict their quantities, and estimate their economic value. This system employs a combination of machine learning models working together to provide accurate predictions with associated confidence metrics. It could further comprise:
5.1 Mineral Classification
5.2 Quantity Prediction
5.3 Economic Value Estimation
5.4 Uncertainty Quantification
5.5 Confidence Scoring
5.6 Integration and Updates

### 6. System Integration Architecture

The integration architecture ensures seamless operation between all AI components and physical systems, providing robust, real-time performance while maintaining safety and reliability. It could further comprise:
6.1 Data Flow Architecture
6.2 Hardware Integration
6.3 Operational Control Flow

### 7. Self-Correction and Learning System

The self-correction and learning systems enable continuous improvement of all AI components through operational experience, ensuring optimal performance and reliability over time. It could further comprise:
7.1 Continuous Learning Framework
7.2 Error Detection and Correction
7.3 Knowledge Integration
7.4 Safety and Reliability
7.5 Long-term Optimization

### 8. Performance and Safety System

This system provides comprehensive monitoring, evaluation, and safety mechanisms, ensuring reliable operation while maintaining clear performance metrics and robust fallback procedures. It could further comprise:
8.1 Performance Metrics Framework
8.2 Fallback Systems
8.3 Emergency Response System
8.4 Fault Tolerance Architecture
8.5 Safety Enforcement
8.6 System Validation

### 9. Economic Optimization System

This section details the economic decision-making capabilities of the AI system, providing comprehensive specifications for market adaptation, cost optimization, and value maximization strategies. It could further comprise:
9.1 Market Intelligence System
9.1.1 Real-time Market Data Integration
9.1.2 Predictive Market Modeling
9.2 Operational Cost Optimization
9.2.1 Dynamic Cost Modeling
9.2.2 Resource Allocation Optimization
9.3 Value Maximization Framework
9.3.1 Grade-Based Optimization
9.3.2 Collection Strategy Optimization
9.4 DQL Agent Economic Integration
9.4.1 Economic State Space
9.4.2 Economic Action Space
9.5 Adaptive Economic Strategy System
9.5.1 Short-term Optimization
9.5.2 Long-term Strategy
9.6 Performance Metrics and Reporting
9.6.1 Economic Performance Metrics
9.6.2 Reporting and Analysis

This comprehensive economic framework ensures optimal financial performance through sophisticated market intelligence, cost optimization, and value maximization strategies. The system's adaptive nature allows for dynamic response to changing market conditions while maintaining operational efficiency.

### 10. Environmental Protection System

This section details the environmental protection mechanisms of the AI system, providing comprehensive specifications for impact assessment, prevention, monitoring, and ecosystem preservation strategies. It could further comprise:
10.1 Environmental Impact Assessment
10.1.1 Physical Impact Monitoring
10.1.2 Ecosystem Impact Assessment
10.2 Preventive Protection Framework
10.2.1 Pre-operation Assessment
10.2.2 Operational Controls
10.3 Real-time Monitoring Systems
10.3.1 Continuous Environmental Monitoring
10.3.2 Adaptive Response System
10.4 AI-driven Protection Mechanisms
10.4.1 Neural Network Environmental Analysis
10.4.2 Protective Decision Making
10.5 Recovery Management System
10.5.1 Post-operation Monitoring
10.5.2 Adaptive Management
10.6 Integration and Reporting
10.6.1 Environmental Performance Metrics
10.6.2 Documentation and Reporting

This comprehensive environmental protection framework ensures responsible resource extraction while maintaining ecosystem integrity through sophisticated monitoring, protection, and recovery systems. The integration of AI-driven decision making enables proactive environmental protection and effective impact mitigation.

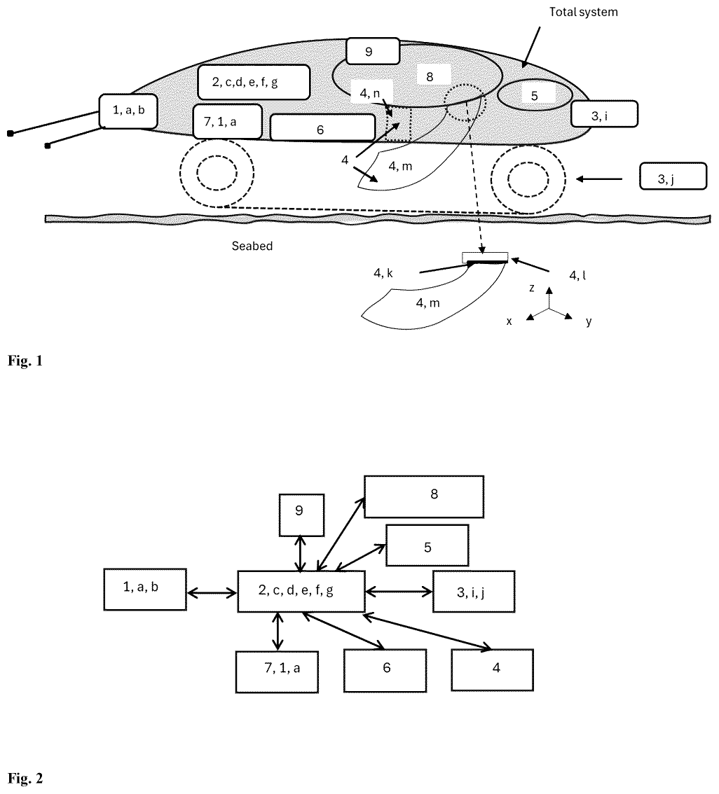

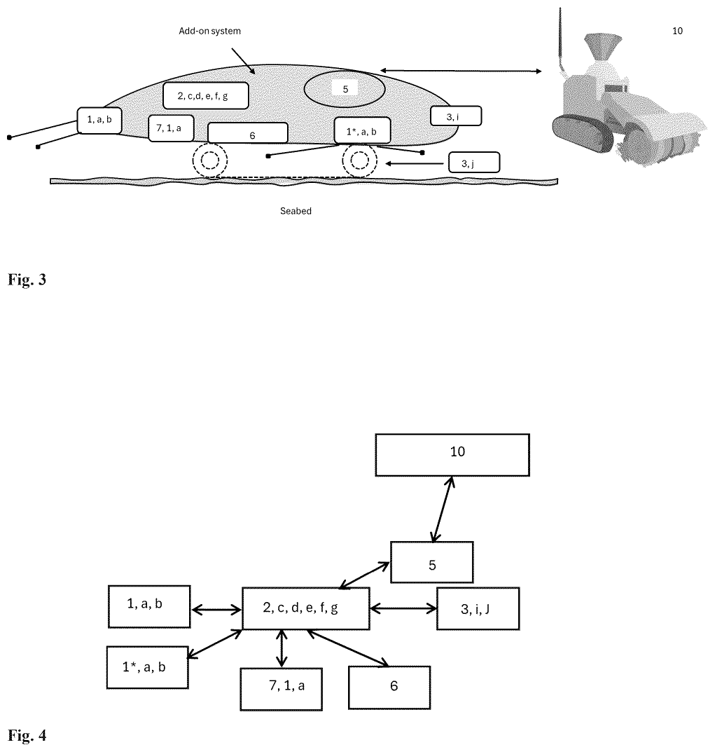

This is an example of primary components and steps within a suggested ML/AI system and/or algorithm. Actual system can vary dependent on actual design of the developed vehicle (FIG. 1, FIG. 3) and/or adaptations to local conditions, at the area of applications.

### 6.2.2 Selv-Correction

With or without AI/ML algorithms, the at least one RTCGS (as of section 6.2) can be designed to correct their own predictions over time and improve their accuracy. This can be achieved through a process of continuous learning and adjustment based on the comparison of predicted and actual outcomes. E.g. in Q-learning, a form of reinforcement learning, a self-correcting algorithm has been proposed to balance the overestimation of the single estimator used in conventional Q-learning and the underestimation of the double estimator used in Double Q-learning. As the algorithm(s) receive(s) feedback about its performance, it could adjust its parameters to improve future predictions and recommendations. As an example, “Advances in Neural Information Processing Systems”, 33 (NeurIPS 2020), Edited by: H. Larochelle and M. Ranzato and R. Hadsell and M. F. Balcan and H. Lin (ISBN: 9781713829546) could provide further details related to Q-learning in “Selv-Correction” contexts.

### 6.3 Example of High-Level Algorithm(s) or Pseudocode(s)

An integral part of the at least one RTCGS (as of section 6.2), would require at least one pseudocode. Programmers need at least a pseudocode or a readable description providing a detailed template for writing a code in a specific language to provide commands to the at least one selection, separation and collection mechanism. Section 6.3.1 is such an example, written in Python.

To separate, but not limited to, manganese crusts, nodules or sulphide deposits from other matter based on electric and/or acoustic parameters, need signal processing. Such a high-level algorithm could, but not limited to, incorporate the following steps:
1. Data Collection: Gather acoustic and/or electric parameter data from the area of interest. This could include e.g., but not limited to, sound speed or velocity, density, acoustic impedance, and attenuation for acoustic parameters, and resistivity or conductivity for electric parameters.
2. Data Preprocessing:
   Filter the acoustic data to remove noise and enhance signal quality.
   Normalize electric sensor data to account for variations in sensor performance and environmental factors.
3. Feature Extraction: Process the collected data to extract meaningful features that can, but not limited to, differentiate between e.g. manganese crusts, nodules and/or sulphide deposits, and other matter. Features could, but not limited to, include statistical descriptors of the signal(s), spectral content, and derived quantities like reflection coefficients.
4. Data Labeling: If not already labeled, the data needs to be classified into categories (e.g., manganese crusts, nodules, sulphide deposits, other matter) based on ground truth information obtained from e.g. samples or previous surveys.
5. Signal Processing: Use the labeled dataset to train a supervised model such as e.g. a Convolutional Neural Network (CNN) model, which can recognize patterns in the feature set that are indicative of different materials.
6. Real Time Classification: Apply the trained model to new data to classify it into categories. Train the model e.g. on labeled datasets where the ground truth (manganese crusts, nodules, sulphide deposits, or other matter) is known. The model will output probabilities for each category, and the highest probability can determine the classification.
7. Separation Decision/Threshold: Incorporate at least e.g. a set of threshold probabilities for the model's output to decide whether the material is a manganese crust, nodules or sulphide deposit of economic value or meets the at least one threshold value (see e.g. section 4.1).
8. Post-Processing: Apply additional rules or filters based on domain knowledge to refine the classification results. For example, geological knowledge about the distribution of these deposits can help in validating the model's output.
9. Verification and Self-Correction: Periodically collect samples of the separated material and analyze them to verify the accuracy of the separation process. Adjust the at least one model and threshold settings based on verification results to improve accuracy.
ML and/or AI techniques could be incorporated as added features in this context.

This example of algorithm(s) leverages both acoustic and/or electric parameters to identify and separate target mineral deposits. For implementation, a dataset of labeled examples to train the classification model and a system capable of executing the algorithm in the deep-sea environment would be most advantageous. Note—This is a high-level overview, and developing fully functional systems would require detailed engineering. None of the above stated features are limited to the stated characteristics. The stated algorithm(s) have to be viewed as example(s). Real implemented algorithms can include more or less statements and/or more or less features.

### 6.3.1 A Python Program

To creating a conceptual outline of a Python program for separating e.g. manganese crusts, nodules and/or sulphide deposits, based on the algorithm(s) outlined in section 6.3, but not limited to, would most likely (also) have to be based on more specific input materials. The algorithms would likely involve signal processing techniques to classify the data accurately. In this example we have included a ML classifier.

```
import numpy as np
import scipy.signal
from sklearn.ensemble import RandomForestClassifier
def preprocess_data(data):
    # Implement preprocessing steps such as normalization, filtering, etc.
    pass
def extract_features(data):
    # Extract relevant features from the data, which could include
statistical,
    # spectral, or temporal features depending on the nature of the data.
    pass
def train_classifier(features, labels):
    # Train a machine learning classifier, such as a random forest,
    # using the extracted features and provided labels.
    classifier = RandomForestClassifier( )
    classifier.fit(features, labels)
    return classifier
def classify_data(classifier, data):
    # Use the trained classifier to predict the class of new data samples.
    features = extract_features(data)
    return classifier.predict(features)
# Example usage:
# Load your dataset containing electric or acoustic parameters
data = np.load(‘data.npy’)
preprocessed_data = preprocess_data(data)
# Assume labels are provided for supervised learning
labels = np.load(‘labels.npy’)
# Feature extraction
features = extract_features(preprocessed_data)
# Train the classifier
classifier = train_classifier(features, labels)
# Classify new data
new_data = np.load(‘new_data.npy’)
predictions = classify_data(classifier, new_data)
```

This is a high-level template pseudocode and would need to be adapted to the specific characteristics of the data and the problem at hand, and as such it must be view as an example. The actual implementation would require detailed knowledge of local geography, of the data acquisition process, the detailed electric and/or acoustic parameters involved, and the specific mechanical extraction solution or arrangement(s) applied for separating, but not limited to, manganese crusts, nodules and/or sulphide deposits from other matter.

### 7. Examples of (Independent) Systems or Vehicles to Distinguish Manganese Crusts, Nodules and/or Sulphide Deposits from Un-Valuable Matter

A system capable of executing the outlined or developed algorithms for separating manganese crusts, nodules and/or sulphide deposits using electric and/or acoustic input and/or generated parameters, would likely be an advanced underwater vehicle, but not limited to, with the following components and/or features. Also see FIG. 1 and FIG. 2 for visual presentations, where the following numbered items represent key components:

### 1. Sensing Unit:

The system would need sensors capable of measuring the electric and/or acoustic parameters of the deposits. These could include combinations of electric field sensors and acoustic transducers.

a. Acoustic Sensors: Could also be applied to collect high-resolution echo data from the seabed, which could help in identifying the location, density and composition of the various materials.

b. Electric Sensors: To measure e.g. the electrical conductivity and/or resistivity of the seabed material, as different minerals have distinct electrical properties, as previously discussed.

### 2. Data Processing Unit:

Equipped with at least one powerful onboard computer to process the collected acoustic and/or electric data obtained from (1), in real-time.

Could also utilize learning and/or self-correcting algorithms to analyze the acoustic and electric data, classify materials, and determine the presence of targeted (high value) minerals. In addition to functionalities, algorithms and/or characteristics outlined and discussed in sections 6.2 and/or 6.3, the following features would be strongly advantageous;

c) Processing Unit with Key Functionalities: This could be the (one) computer in question or an added microcontroller that runs the at least one separation algorithm. It would take the sensor data as input and output commands to the separation and collection mechanism (4).

d) Data Acquisition Sub-System: This sub-system would collect the data from the sensors and convert them into a format that can be processed. This often involves analogue-to-digital conversion, but not necessary.

e) Wavelet-Based Algorithm: Could Improve signal quality by reducing system interference and ambient noise. It may include a wavelet-based envelope extraction method, and an adaptive estimation strategy based on dual-channel information.

f) Wavelet Regression: Can be applied to reduce measuring noise, assuming that the crusts have local thickness invariability. This is particularly useful for crusts with a structure of multilayers at the top surface and a single layer at the bottom surface.

g) User Interface: This would allow the user (synonymous to “master control station”) to start and stop the process, adjust parameters, and monitor the system's status. The user can be located top-side (manned or un-manned surface vessel) and/or be a submerged manned or un-manned (independent) machine and/or a vehicle (10).

### 3. Navigation and Mobility System:

i) A propulsion system that allows the vehicle to maneuver over the seabed with precision. This could be any combination of propellers and/or impellers. Any possible intake(s) for water jet is not shown. This would enable free movements in water and/or on the seabed.

j) And/or a propulsion system that can include any combination of wheels and/or belts. This would enable movements on the seabed.

Autonomous navigation capabilities guided by sonar and/or GPS to move to specific coordinates, could be used.

### 4. Separation and Collection Mechanism:

Based on output from the at least one RTCGS (as of sections 6.2 and 6.3) and a processor (2), a separation and collection arrangement, functionality and/or sub-system, will be applied. This could be an electro-mechanical system that physically selects and/or separates the deposits based on the commands from the processing unit (2). The exact nature of this mechanism would or could depend on the physical properties of the deposits and the environment in which they are found.

As an example of such a mechanism could be at least one degrees of freedom robotic arm, a trunk and/or proboscis arrangement (4, m), which could combine or represent any combinations of, but not limited to, a suction device, a claw and/or a cutting, crushing or grinding (synonymous terms) device, to collect the identified mineral deposits of value. Examples of such (independent) mechanisms, are;

Example of a suction robotic arm.
https://www.powderbulksolids.com/dust-collection/flexible-dust-extraction-arms

Example of a robotic claw arm. Source:
https://thinkrobotics.com/products/high-precision-industrial-robot-arm-with-planetary-stepper-motors

Example of a cutter assembly. Jackson, E. and Clarke, D. “Excavation of Seafloor Massive Sulphides.” Ocean 2007. Source:
www.researchgate.net/publication/224305659_Subsea_Excavation_of_Seafloor_Massive_Sulphides.

Such a robotic arm and/or trunk (4, m) would operate with at least one degree of freedom (4, l-letter l) (x, y, z) on the outside of the vehicle (FIG. 1). This movement and/or rotational component (4, l-letter l) will receive output signals from the at least one processor (2).

The collector or separator (separation and collection mechanism) (4) can include additional sensors (ref. section 6.1). These can be, but not necessarily, of any acoustic and/or electronic type.

The collector component or a robotic arm and/or a trunk (4, m) can be replaceable or interchangeable with a different collector component or a robotic arm and/or a trunk (4, m) with other arrangements (e.g. any combination of, but not limited to, a suction device, a claw, cutting features, sensors) depending on local conditions. This to maximize profit level(s). The connecting mechanism (4, k) of such an interchangeable collector component (4, m) can be, but is not limited to, an electro-mechanical bayonet type of arrangement. The collector (4) and the collector component (4, m) can be identical arrangements, and/or (4) can represent additional features, like e.g. sensors, located between (4, m) and the at least one local storage unit (8). This or these intermediate elements are not shown.

The connecting mechanism (4, k) and the potential rotational component (4, l-letter l) can be integrated into one unit.

The collector (4) can be built-in within the vehicle (4, n), (FIG. 1), meaning it does not stick out, providing the belly of the vehicle or system (FIG. 1) to be smooth.

Further engineering examples of a dynamic electro-mechanical robotic arm (4), a trunk (4), (4, m), a movement and/or a rotational component (4, l-letter l), can be represented by;
Esposito, D. et al, “Design and Evaluation of a Low-Cost Electromechanical System to Test Dynamic Performance of Force Sensors at Low Frequencies,” Machines 2022, 10 (11), 1017; https://doi.org/10.3390/machines10111017.
Lu, Y., Lu, X., Ye, G. et al. «Study of electromechanical coupling dynamical characteristics of the grinding robot joint transmission system”, Eur. Phys. J. Plus 139, 767 (2024). https://doi.org/10.1140/epjp/s13360-024-05577-2.
Palpacelli, M, et al, “Details on the Design of a Lockable Spherical Joint for Robotic Applications,” Journal of Intelligent & Robotic Systems 81 (2), April 2015, DOI: 10.1007/s10846-015-0230-2.

### 5. Communications and Navigation System:

Represents a robust communication device or link enabling to transmit data and receive instructions from the surface and/or submerged master control station (user) and/or at least one external vessel (10). May include acoustic modems for underwater communication and satellite links when at the surface. Will most likely include a GPS tracking device.

### 6. Power Supply:

A combination of e.g. batteries and possibly fuel cells to provide long-duration power supply for extended missions, or any other wireless and/or wired power supply.

7. Environmental Monitoring and/or Sonar:

Sensors to monitor environmental parameters to ensure compliance with environmental regulations and minimize the ecological impact.

Could and/or represent a sonar, most probably an acoustic device (1, a). It could provide added navigational data and/or a global overview of the area or seabed in question.

### 8. Local Storage Unit:

A storage unit to hold the collected minerals until they can be transported to the surface, or it could be connected to the surface by a (flexible) hose (not shown).

### 9. Hatch or Locking Device:

Arrangement to connect an external storage unit (not shown), (e.g. a vessel and/or a tank) to the local storage unit (8). The means of connection could be any combinations of a pipeline and/or a flexible hose (not shown on any of the figures).

The total system is represented by components 1-9.

Additional sensors (ref. section 6.1) can be located on and/or within a vehicle (FIG. 1) (not shown).

The total system (1-9) could be deployed from both at least one surface vessel (not shown) and/or at least one existing external underwater production vehicle or device (10) and/or be remotely operated and/or be programmed to perform autonomous missions. It would execute the algorithms by collecting data, processing then to identify target valuable minerals, and then physically selecting and/or separating and storing the valuable minerals for retrieval. The degree of separation can vary, ref. discussion related to listing (j) in section 4.1. The design would need to be robust to withstand the harsh conditions of the deep-sea environment. This is an example. Actual systems could include both fewer or additional added features and/or additional algorithms, and would require multidisciplinary engineering and computer science to be commercially designed.

The developed systems facilitate added profitability and reduce environmental impacts.

The at least one component, feature and/or system(s) as outlined in section 7 and FIG. 1 and FIG. 2 could (also) be totally or partially integrated into existing deep-sea mining vehicles (10), to execute algorithms for the selection and/or separation, but not limited to, of manganese crusts, nodules or sulphide deposits based on electric or acoustic parameters. These systems (or harvesting machines) (10) could then be capable of distinguishing these materials from other matter, thus facilitating more profitable, efficient and targeted mining operations. Examples of such mining machines (10) are discussed in section 3 (Prior Art).

### 8. AN ADD-ON SYSTEM OR A PATHFINDER TO AN EXISTING OFFSHORE MINERAL EXTRACTION VEHICLES

A high-level description of an add-on system (“path finder”), capable of executing algorithms for, but not limited to, separating manganese crusts and/or sulphide deposits using electric and/or acoustic parameters, for at least one external offshore mining vessel (10), has been provided. Examples of such existing external offshore mining vessels are described or discussed in the Prior Art section (section 3).

Such an add-on system(s) is/are described as outlined in FIG. 3 and FIG. 4:

It would include, but not necessarily, the components, features and/or characteristics of sections 6 and 7. However, the components 4, 8 and 9 could be excluded. Added acoustic and/or electronic components (1*, a, b) could be advantageous. The at least one communication unit (5) could be wireless or wired to the at least one external vessel or harvesting machine (10), which can collect minerals and/or objects from the seafloor. If the at least one add-on system is wired to the at least one external vessel (10), it could be powered by the at least one external vessel (10) and the internal power unit (6) could be abandoned. The at least one add-on system would guide or direct the at least one external vessel (10) by input data representing economic sound concentrations of valuable minerals, ref. section 4.1, and provide added profitability and reduced environmental impacts.

Additional sensors (ref. section 6.1) can be located on and/or within a vehicle (FIG. 3) (not shown).

The path finder (FIG. 3, FIG. 4) can be remotely operated and/or be programmed to perform autonomous missions.

This is an example of a high-level conceptual design, and the actual implementation(s) would require detailed engineering design and testing. It's also important to consider safety, environmental impact, and legal regulations when designing such a system.

The at least one component, feature and/or system(s) as outlined in section 8 and FIG. 3 and FIG. 4, based on discussions in sections 6 and 7, could (also) be totally or partially integrated into existing deep-sea mining vehicles (10) to execute algorithms for the selection and/or separation, but not limited to, of manganese crusts, nodules or sulphide deposits based on electric or acoustic parameters. These systems (or harvesting machines) (10) could then be capable of distinguishing these materials, partially or fully, ref. discussion under listing (j) section 4.1, from other matter, thus facilitating more profitable, efficient, environmentally friendly and targeted mining operations.

Examples of such mining machines (10) are discussed in section 3 (Prior Art).

### 9. DISCUSSION

### 9.1 Further Prior Art

During the course of national examination, several (new) closest prior art were proposed (D1-D5), of which D1 (EP 3719252 B1) was stated to be the closest.

A detailed analysis of D1 reveals a seabed mining system with collectors that:
Scan the seabed using sonar sensors to detect nodule abundance (section [0031]),
Implement abundance-based decisions for determining collection readiness, (section [0031]:37 . . . send an instruction to the collecting device to prepare for collection if the nodule abundance satisfies a predetermined requirement”),
Provide communication between collectors and a main module for sending collection instructions (section [0079]: “sonar based communication, e.g. by a sensor suit provided on each collecting device”),
Use a general collection mechanism without selective capabilities (FIGS. 1A and 1B).

However, upon thorough examination of D1's technical teaching, we identify the following fundamental technical limitations:

### Absence of Material Classification Capability:

D1 cannot differentiate between different types of minerals (e.g. manganese crusts, nodules, sulphide deposits) and unprofitable matter,
D1 only detects the presence and quantity of nodules without any classification of their type, composition, or economic value,
No signal processing for material identification is disclosed or suggested.

### Lack of Physics-Based Analysis Mechanisms:

No utilization of specific acoustic parameters (e.g. sound velocity, acoustic impedance, attenuation) for material differentiation,
No implementation of electric property analysis (e.g. resistivity, conductivity) for mineral identification,
No sensor array or signal processing algorithms capable of detecting the physical properties that would enable classification.

### Absence of Economic Assessment Architecture:

No capability to determine economic viability beyond simple abundance thresholds,
No integration of mineral value, extraction costs, or profitability metrics,
No dynamic threshold determination based on economic parameters.

### Limited Collection Mechanism:

No selective harvesting based on material classification,
No integration between detection systems and targeted collection,
Inability to discriminate between valuable and non-valuable materials during collection.

These limitations are inherent to D1's fundamental technical approach and architecture, which focuses solely on abundance detection rather than material classification and selective extraction.

### 9.1.1 Objective Technical Problem

With reference to chapter 3 (Prior Art), we elaborate the structured approach prescribed in e.g. EPO Guidelines G-VII, 5.3, and based on the identified differences between our claimed invention and D1, we re-formulate and generalize the objective technical problem as:

“How to improve the selectivity and economic efficiency of offshore mineral collection by distinguishing between valuable and non-valuable materials in real-time using physical properties of the materials.”

This formulation:
Avoids hindsight by being derived directly from the technical differences between D1 and our invention,
Addresses a genuine technical challenge in the field of offshore mineral extraction,
Focuses on the core technical problem of differentiation and selectivity,
Aligns with the technical effects achieved by our invention's distinctive features.

The objective technical problem is clearly articulated in our application, particularly in Section 4 (page 14), which states: “The overall objective technical problem to be solved by the invention is the development of intelligent systems to . . . locate and partially or fully extract economic sound concentrations of any combinations of nodules, manganese crusts and/or sulphide deposit, thus select and separate uneconomic matter from valuable minerals.”

### 9.1.2 the Technical Solution and its Non-Obviousness

Our application presents a comprehensive technical solution through a sophisticated integrated system that combines:
Advanced Multi-Parameter Sensor Technology (detailed in Sections 5.1-5.2.2) that detects, e.g:
Specific electrical parameters including conductivity (ranging from 10⁻² to 10⁷ S/m), resistivity (10² to 10⁸ ohm-m), and dielectric properties,
   Precise acoustic parameters including sound velocity (4,000 to 7,000 m/s), acoustic impedance (15 to 30 MRayl), and attenuation (0.1 to 2 dB/m),
   Specialized parameter ranges specifically calibrated for sulphide deposits and manganese crusts/nodules.

Sophisticated Signal Processing Architecture (detailed in Sections 6.2-6.3) featuring e.g.: Multi-stage signal conditioning including noise filtering and normalization,
Feature extraction algorithms identifying distinctive fingerprints of mineral types,
Classification algorithms trained on labeled datasets of different mineral compositions,
Real-time processing capabilities for in-situ decision making.

Economic Assessment Framework (detailed in Section 4.1) incorporating e.g.:
Quantifiable thresholds based on mineral density, composition, and concentration,
   Dynamic profitability models considering extraction costs, market values, and operational parameters,
   Multi-factor decision matrices weighing technical, economic, and environmental factors,
   Adaptive threshold determination responsive to changing conditions.

Intelligent Selective Collection Mechanism (detailed in Section 7) comprising e.g.: Precision end-effectors (robotic arms, suction devices, claws) with multiple degrees of freedom,
Direct integration with the classification system for targeted extraction,
Feedback-based operation for selective collection optimization,
Precision movement and actuation systems for minimal environmental disturbance.

This integrated solution represents a significant advancement over the prior art that is not rendered obvious by D1-D5, either individually or in combination, as demonstrated through the following detailed analysis:
D1 (EP 3719252 B1):
   Limited to Binary Detection: D1 only implements binary abundance detection (above/below threshold) without any material classification capabilities,
   No Physics-Based Analysis: D1 lacks any sensor system capable of measuring the specific physical properties required for material identification,
   Simplistic Decision Logic: D1 implements basic threshold-based collection decisions without economic or value-based assessment,
   Non-Selective Collection: D1's collection system cannot discriminate between different mineral types or economic value during extraction.
D2 (WO 2023063831 A1):
   Focus on General Collection: D2 discusses methods for sampling manganese nodules using sonar and collectors, but lacks any classification system,
   Absence of Decision Framework: D2 contains no economic decision logic to guide selective collection,
   No Integration Architecture: D2 fails to teach integration between sensing and selective collection based on material properties,
   Limited Sensor Capabilities: D2 does not disclose sensors capable of detecting the acoustic and electric parameters necessary for material differentiation.
D3 (US2022187227 A1):
   Autonomous Navigation Focus: D3 concentrates on autonomous vehicle navigation without intelligent classification capabilities,
   Lacking Sensor Integration: D3 does not disclose integration between sensor data and economic viability assessment,
   No Selective Extraction: D3 contains no teaching regarding selective collection mechanisms,
   Different Technical Field: D3 addresses vehicle control rather than material discrimination and selective harvesting.
D4 (WO 2023183651 A1):
   General Deep-Sea Systems: D4 discusses deep-sea mining systems with robotic arms but lacks classification capabilities,
   No Parameter Analysis: D4 lacks disclosure of acoustic/electric parameter analysis for material identification,
   Absent Economic Framework: D4 contains no economic assessment mechanisms for determining collection value,
   Different Technical Approach: D4 focuses on mechanical aspects rather than intelligent, selective extraction.
D5 (EP 4005917 A1):
   Inspection Focus: D5 relates to underwater inspection apparatus without mineral differentiation capabilities,
   Limited to Mapping: D5 focuses on mapping rather than extraction or collection,
   No Economic Assessment: D5 contains no framework for economic assessment or value determination,
   Different Technical Purpose: D5 addresses identification of predefined objects rather than classification of natural mineral deposits.

To reemphasize what was discussed in section 3, the e.g. EPO Guidelines (G-VII, 5.1 and 8) explicitly caution against combining more than two prior art documents unless a clear motivation exists in the prior art itself. The combination of D1 with any or all of D2-D5 would constitute impermissible hindsight and require unrealistic leaps across disparate technical fields (robotics, geology, machine learning, signal processing, mineral economics) without any unifying suggestion or teaching within the prior art.

Moreover, even if one were to attempt such a combination, the result would still lack the integrated, synergistic system described in our application. The selective extraction based on real-time physics-based classification and economic assessment represents a novel technical approach not suggested by any of the cited documents, even in combination.

### 9.1.3 Novel Technical Synergy

The claimed invention introduces a novel technical synergy between three sophisticated technical domains that produces unexpected technical effects:
Sensor-based real-time data acquisition using specific physical parameters:
   High-resolution detection of multiple physical parameters simultaneously,
   Specialized measurement ranges calibrated for seabed mineral identification,
   Real-time processing of complex sensor data in challenging underwater environments,
   Multi-modal data fusion combining acoustic and electric property analysis.
AI/ML classification based on acoustic/electric property analysis:
   Sophisticated signal processing algorithms extracting distinctive features from raw sensor data,
   Machine learning models trained specifically for underwater mineral classification,
   Real-time implementation of classification algorithms in resource-constrained environments,
   Adaptive classification systems capable of operating in varying conditions.
Autonomous selective extraction systems responsive to economic thresholds:
   Precision mechanical systems directly controlled by classification outputs,
   Multi-axis collection mechanisms with fine-grained control,
   Selective extraction targeting only economically viable materials,
   Integration of sensing, classification, and collection in a closed-loop system.

This technical synergy produces measurable technical effects that represent significant advancements over the prior art:
Enhanced Resource Efficiency: Reduced energy consumption through selective extraction (significant improvement potential based on the specific mineral concentrations described in Section 2.1),
Improved Economic Returns: Higher-value extracted materials through precise discrimination (potentially doubling effective yield as implied by the concentration differentials in Section 5.3.2),
   Reduced Environmental Impact: Minimized seabed disruption through targeted collection (as detailed in Section 10),
   Operational Optimization: Reduced processing requirements through pre-filtering of low-value materials (Section 4).

None of the cited prior art documents, alone or in combination, suggests this synergistic technical approach to the objective technical problem, nor do they hint at the significant technical advantages achieved by this synergy.

### 9.2 Practical Engineering Solution I—How the Invention/System(s) can Determining Locations where Economically Sound Concentrations are Identified

In practical engineering solutions. ML/AI capabilities will most likely be incorporated. Thus, adequate and/or willful features discussed in section 6.2.1 and the Appendix, will be incorporated related to the actual specifics or application in question.

The application provides exceptionally detailed disclosure across multiple sections, offering a complete technical roadmap for implementing this feature, e.g.:

### a) Physical Parameter Measurement (Section 5)

The application provides extensive scientific basis for differentiating minerals using acoustic and electric properties, including specific parameter ranges and measurement techniques:

### Electrical Properties:

Conductivity Ranges: “Electrical Conductivity: This can vary widely from 10⁻² to 10⁷ S/m. For example, metallic minerals like native copper can have very high conductivity, while minerals with covalent bonds like quartz have much lower values.” (Section 5.1),
Resistivity Values: “Resistivity: Common rock types can have resistivity values ranging from 10² to 10⁸ ohm-m. Sulfide minerals, which often have partially metallic bonds, tend to have lower resistivity.” (Section 5.1),
Dielectric Properties: “Dielectric Constant: This is typically in the range of 2 to 200 for most minerals. It's a measure of a mineral's insulating ability.” (Section 5.1),
Sulphide-Specific Parameters: “Frequency-Dependent Complex Electrical Resistivity: SMS deposits exhibit frequency-dependent complex electrical resistivity in the range between 0.002 and 100 Hz.” (Section 5.1.2).

### Acoustic Properties:

Sound Velocity: “Sound velocity: For minerals, the longitudinal sound velocity typically ranges from 4,000 to 7,000 m/s.” (Section 5.2),
Acoustic Impedance: “Acoustic impedance (Z): This parameter is defined as the product of the density of the material and the sound velocity through it. For most minerals, acoustic impedance can range from 15 to 30 MRayl (mega ray-leighs).” (Section 5.2),
Attenuation: “Attenuation (a): Attenuation rates can be high in sulphide deposits due to the complex structure and can range from 0.1 to 2 dB/m.” (Section 5.2.1),
Mineral-Specific Parameters: “The acoustic properties of seafloor massive sulfide deposits are influenced by their mineral composition and porosity. Understanding these properties is crucial for interpreting sub-seafloor images from geophysical surveys.” (Section 5.3.2).

These detailed technical specifications provide explicit parameter ranges and measurement techniques necessary for sensor configuration and detection algorithm development, giving the skilled person clear guidance for implementation.

### b) Real-Time Control Systems (Section 6.2)

The application thoroughly details the real-time control and guidance systems necessary for location identification and decision-making:
Real-Time Control Requirements: “A control operation is a series of events or actions occurring within system hardware and software to give a specific result. A real-time control system is a system in which the correctness of a result depends not only on its logical correctness but also on the time interval in which the result is made available.” (Section 6.2),
Specific Control Algorithms: “Based on e.g. combinations of, but not limited to, Model Predictive Control, (MPC), Proportional Integral Derivative (PID), Deep Reinforcement Learning (DRL), three characteristics of ML/AI-based controllers can be utilized . . . ” (Section 6.2),
Implementation Steps: “The enablement of e.g. DRL-based control systems to a process facility, require, but are not limited to, the following steps in delivering a DRL-based controls: 1. Preparation of a companion simulation model for the (AI) brain, 2. Design and training of the (AI) brain, 3. Assessment of the trained (AI) brain, 4. Deployment.” (Section 6.2),
Self-Correction Mechanisms: “With or without AI/ML algorithms, the at least one RTCGS (as of section 6.2) can be designed to correct their own predictions over time and improve their accuracy. This can be achieved through a process of continuous learning and adjustment based on the comparison of predicted and actual outcomes.” (Section 6.2.2).

These detailed control system specifications provide concrete algorithmic approaches and implementation methodologies, giving the skilled person explicit guidance on developing the control architecture necessary for the invention.

### c) Signal Processing Algorithms (Section 6.3)

The application provides a comprehensive high-level algorithm for processing sensor data and making mineral classification decisions:
Algorithm Structure: “Such a high-level algorithm could, but not limited to, incorporate the following steps: 1. Data Collection, 2. Data Preprocessing, 3. Feature Extraction, 4. Data Labeling, 5. Signal Processing, 6. Real Time Classification, 7. Separation Decision/Threshold, 8. Post-Processing, 9. Verification and Self-Correction” (Section 6.3),
Feature Extraction: “Process the collected data to extract meaningful features that can, but not limited to, differentiate between e.g. manganese crusts, nodules and/or sulphide deposits, and other matter. Features could, but not limited to, include statistical descriptors of the signal(s), spectral content, and derived quantities like reflection coefficients.” (Section 6.3),
Classification Logic: “Apply the trained model to new data to classify it into categories. Train the model e.g. on labeled datasets where the ground truth (manganese crusts, nodules, sulphide deposits, or other matter) is known. The model will output probabilities for each category, and the highest probability can determine the classification.” (Section 6.3),
Decision Implementation: “Incorporate at least e.g. a set of threshold probabilities for the model's output to decide whether the material is a manganese crust, nodules or sulphide deposit of economic value or meets the at least one threshold value (see e.g. section 4.1).” (Section 6.3).

These detailed algorithm descriptions provide step-by-step guidance for implementing the signal processing and decision-making components, giving the skilled person clear direction for software development.

### d) Complete Implementation Example (Section 6.3.1)

The application provides a complete Python implementation example that demonstrates the key algorithms, see chapter 6.3.1 for details.

This complete code example provides explicit implementation details for the classification system, giving the skilled person ready-to-use algorithms that can be adapted to specific hardware configurations.

### e) Economic Assessment Framework (Section 4.1)

The application provides detailed criteria for determining “economically sound concentrations” of minerals:
Density Assessment: “The density of any combinations of nodules, manganese crusts and/or sulphide deposit can vary on the seabed. It can be measured as numbers and/or weight (kg) per area (m²).” (Section 4.1.a),
Composition Evaluation: “The mixture or composition of valuable minerals can vary as a function of area.” and “The concentration of various valuable minerals within e.g. nodules, manganese crusts and/or sulphide deposit vs un-valuable matter can vary (%).” (Section 4.1.b-c),
Cost Factors: “Location can be a cost issue (e.g. distance to shore and general weather conditions can represent added cost elements).” and “Depth can be a cost issue.” (Section 4.1.d-e),
Market Considerations: “Commodity prices can vary.” and “Definition of profits and/or rate of return(s) and/or interest rates can vary.” (Section 4.1.g-i),
Threshold Determination: “A certain level of ‘economic sound concentrations’ or ‘profit level(s)’ will define a ‘threshold’ or a targeted profitable value (or number). A ‘number’ can be gross profits/week in USD, based on type of mineral (tons) multiplied by the commodity price for the specific mineral, and summarize for all the minerals in question.” (Section 4.1).

These detailed economic parameters provide explicit criteria for determining economically viable deposits, giving the skilled person clear guidance on implementing the decision-making logic necessary for selective collection.

The combination of these extensive technical details across multiple sections provides far more than sufficient guidance for a skilled person to implement the “determining locations where economically sound concentrations are identified” aspect of the invention without undue experimentation.

### 9.3 Practical Engineering Solution II—how the Invention/System Collector that Selectively Collects the Identified Deposits

In practical engineering solutions, ML/AI capabilities will most likely be incorporated. Thus, adequate and/or willful features discussed in section 6.2.1 and the Appendix, will be incorporated related to the actual specifics or application in question.

The application provides remarkably detailed implementation information for the selective collection mechanism, e.g.:

### a) COLLECTOR ARCHITECTURE (SECTION 7)

The application thoroughly describes the structure and operation of the collector mechanism:
System Overview: “Based on output from the at least one RTCGS (as of sections 6.2 and 6.3) and a processor (2), a separation and collection arrangement, functionality and/or sub-system, will be applied. This could be an electro-mechanical system that physically selects and/or separates the deposits based on the commands from the processing unit (2).” (Section 7.4),
Collection Mechanisms: “As an example of such a mechanism could be at least one degrees of freedom robotic arm, a trunk and/or proboscis arrangement (4, m), which could combine or represent any combinations of, but not limited to, a suction device, a claw and/or a cutting, crushing or grinding (synonymous terms) device, to collect the identified mineral deposits of value.” (Section 7.4),
Movement Control: “Such a robotic arm and/or trunk (4, m) would operate with at least one degree of freedom (4, l-letter l) (x, y, z) on the outside of the vehicle (FIG. 1). This movement and/or rotational component (4, l-letter l) will receive output signals from the at least one processor (2).” (Section 7.4),
Engineering References: “Lu, Y., Lu, X., Ye, G. et al. «Study of electromechanical coupling dynamical characteristics of the grinding robot joint transmission system”, Eur. Phys. J. Plus 139, 767 (2024). https://doi.org/10.1140/epjp/s13360-024-05577-2.” (Section 7.4).

### b) INTEGRATION WITH CLASSIFICATION SYSTEM (SECTIONS 7.4)

The application explicitly details how the collection system integrates with the classification output:
Command Flow: “Based on output from at least one RTCGS (as of sections 6.2 and 6.3) and a processor (2), a separation and collection arrangement, functionality and/or sub-system, will be applied.” (Section 7.4),
Selective Extraction: “The collector (FIGS. 1; 4, FIGS. 2; 4) can be built-in within the total system (FIG. 1).” and “ . . . the collector (FIGS. 1; 4, FIGS. 2; 4) that selectively collects the identified mineral deposits based on the identified locations . . . ” (Section 9),
Feedback Integration: “Verification and Self-Correction: Periodically collect samples of the separated material and analyze them to verify the accuracy of the separation process. Adjust the at least one model and threshold settings based on verification results to improve accuracy.” (Section 6.3).

### c) DETAILED VISUAL REPRESENTATIONS (FIGS. 1-4)

The application provides comprehensive visual representations of the collection system:

FIG. 1: Shows the complete system architecture with sensor placement, processor connections, and collector mechanism integration,

FIG. 2: Provides a detailed view of the collector components,

FIG. 3: Illustrates the add-on system configuration,

FIG. 4: Shows the communication pathways between components.

### d) SPECIFIC IMPLEMENTATION EXAMPLES (SECTION 7.4)

The application provides multiple concrete examples of implementation approaches, e.g.:
Suction-Based Collection: “Example of a suction robotic arm.” (Section 7.4, with accompanying figure),
Claw-Based Collection: “Example of a robotic claw arm.” (Section 7.4, with accompanying figure),
Cutting-Based Collection: “Example of a cutter assembly.” (Section 7.4, with accompanying figure(s) and reference).

The combination of these extensive technical details across multiple sections provides far more than sufficient guidance for a skilled person to implement the “collector that selectively collects the identified deposits” aspect of the invention without undue experimentation.

### 9.4 Integration of Complete System

The application further provides detailed information on how the various components integrate into a complete, functional system:

### 1. System Architecture (Section 7):

Detailed descriptions of sensor placement and integration (Items 1, 1a, 1b in FIG. 1),
Processor connectivity and data flow (Item 2 in FIG. 1),
Collection mechanism integration (Item 4 in FIG. 1),
Storage and transport components (Items 8, 9 in FIG. 1),

### 2. Communication Infrastructure (Sections 5, 7):

Data transmission between sensors and processors,
Command transmission between processors and collection mechanisms,
External communication capabilities (Item 5 in FIG. 1),

### 3. Power Systems (Section 7.6):

“A combination of e.g. batteries and possibly fuel cells to provide long-duration power supply for extended missions, or any other wireless and/or wired power supply.” (Section 7.6).

### 4. Operational Integration (Section 10):

Complete system operation workflow,
Component interaction during operation,
Implementation variations for different deployment scenarios.

The application thus provides a complete technical roadmap for implementing every aspect of the claimed invention, from sensor configuration through signal processing to selective collection mechanisms, with detailed technical parameters, algorithmic approaches, and implementation examples throughout.

### 9.4.1 Further System Features

The selective collection mechanism enabled by our invention delivers significant technical benefits beyond prior art capabilities:

### a) Enhanced Resource Efficiency:

The selective extraction will reduce energy consumption significantly compared to non-selective approaches (implied by the mineral concentration differentials in Section 2.1),
Processing requirements are reduced through pre-filtering of low-value materials (Section 4),
Collection precision reduces wear on mechanical systems and extends operational life.

### b) Reduced Environmental Impact:

Minimized seabed disruption through targeted collection (entire document),
Reduced water column turbidity through selective extraction,
Preservation of non-target seabed habitats,
Lower overall ecological footprint per unit of valuable mineral extracted.

### c) Operational Optimization:

Improved yield quality through material discrimination,
Reduced transportation and processing costs,
Enhanced system reliability through more precise operation,
Dynamic adaptation to varying seabed conditions.

These benefits directly result from the technical features of our invention and represent meaningful technical advantages over the prior art. They align with e.g. the EPO's recognition of environmental improvements as legitimate technical effects that can contribute to inventive step assessment.

### 10. OPERATIONAL INTEGRATION—FAVORABLE TOTAL MECHANISMS AND/OR SYSTEMS

A favorable total, independent and/or add-on system for offshore mineral mining could comprise at least one of the following components and/or features:

At least one electric and/or acoustic sensor (FIGS. 1; 1 a, b, FIGS. 2; 1, a, b) wherein mineral deposits can be identified and can be separated, but not limited to, manganese crusts, nodules or sulphide deposits from other matter based on electric and/or acoustic parameters (FIGS. 1; 1, 2, 4, FIGS. 2; 1, 2, 4),
wherein the at least one electric and/or acoustic sensor (FIGS. 1; 1, a, b, FIGS. 2; 1, a, b) can measure at least one of, but are not limited to, electric conductivity, resistivity, dielectric properties, centroid frequency, ultrasonic characteristics, sounds, velocities, density, acoustic impedance, attenuation, of seabed material to identify mineral deposits, and generates data signals based on the sensed parameters;
at least one processor (FIGS. 1; 2, FIGS. 2; 2) that processes the signals, wherein the processor utilizes signal processing to identify the economic sound concentrations of the mineral deposits based on the data signals;
and at least one of;
   a collector (FIGS. 1; 4, FIGS. 2; 4) that selectively collects the identified mineral deposits based on the identified locations determined by the processor. The collector can, comprise an at least one degree of freedom of any combinations of, a robotic arm, a trunk, a claw, a cutting device or a suction-based system and a storage unit (FIGS. 1; 8, FIGS. 2; 8) to hold the collected minerals,
   a communication device (FIGS. 3; 5, FIGS. 4; 5) which is in communication with at least one external vessel (FIGS. 3; 10, FIGS. 4; 10),
   at least one component (1-9) and/or feature (a-n) (FIG. 1, FIG. 2 and/or FIG. 3, FIG. 4) can be totally or partially integrated into a vehicle (10).

Wherein the at least one sensor (FIGS. 1; 7, FIGS. 2; 7 and/or FIGS. 3;7, FIGS. 4;7) includes an acoustic sensor that senses echo data from the seabed to identify mineral deposits.

Wherein the mineral deposits to be identified and can be separated (FIGS. 1; 4), but not limited to, manganese crusts, nodules or sulphide deposits from other matter based on electric and/or acoustic parameters (FIGS. 1; 1, 2, 4, FIGS. 2; 1, 2, 4).

The system further comprising a vehicle that is maneuverable (FIGS. 1; 3) in water and/or over the seabed or a vehicle that is maneuverable (FIGS. 3; 3) in water and/or over the seabed.

The system wherein a vehicle (FIG. 1) includes a storage unit (FIGS. 1; 8) that holds the mineral deposits collected by the collector (FIGS. 1; 4, FIGS. 2; 4).

The system wherein a vehicle (FIG. 1) include(s) a communication device (FIGS. 1; 5, FIGS. 2; 5) and/or the vehicle (FIG. 3) include(s) a communication device (FIGS. 3; 5, FIGS. 4; 5) configured to transmit and receive information with a master control station and/or at least one external vessel (FIGS. 3; 10, FIGS. 4; 10).

The system wherein a vehicle (FIG. 1) include(s) at least one environmental monitoring sensor (FIGS. 1; 7) to ensure compliance with regulations and to minimize environmental impact by the collector (FIGS. 1; 4, FIGS. 2; 4).

The system of wherein a separator (FIGS. 1; 4, FIGS. 2; 4), based on output data from the at least one processor (2), that separates and/or collects the identified mineral deposits from other matter that is identified on the seabed, to differentiate and/or collect the identified mineral deposits from the other matter, wherein the separator is operated by the processor (FIGS. 1; 2, FIG. 2; 2) to differentiate and/or collect the identified economically sound concentrations of mineral deposits from other matter.

Additional sensors (ref. section 6.1) can be located on and/or within a vehicle (FIG. 1, FIG. 3) (not shown).

A method for offshore mineral mining, comprising at least one of the following components and/or features:
At least one electric and/or acoustic sensor (FIGS. 1; 1, a, b, FIGS. 2; 1, a, b) that senses parameters of an area of interest on a seabed to identify mineral deposits and generates data signals based on the sensed parameters;
At least one processor (FIGS. 1; 2, FIGS. 2; 2) that processes the signals and determines locations on the seabed where economically sound concentrations, determined using quantifiable thresholds of mineral deposits are identified, wherein the processor utilizes signal processing to identify the economic sound concentrations of the mineral deposits based on the data signals;
   and at least one of;
a collector (FIGS. 1; 4, FIGS. 2; 4) that selectively collects the identified mineral deposits based on the identified locations determined by the processor. The collector can, comprise an at least one degree of freedom of any combinations of, a robotic arm, a trunk, a claw, a cutting device or a suction-based system and a storage unit (FIGS. 1; 8, FIGS. 2; 8) to hold the collected minerals,
a communication device (FIGS. 3; 5, FIGS. 4; 5) which is in communication with at least one external vessel (FIGS. 3; 10, FIGS. 4; 10),
at least one component (1-9) and/or feature (a-n) (FIG. 1, FIG. 2 and/or FIG. 3, FIG. 4) can be totally or partially integrated into a vehicle (10).

The method further comprising a vehicle that is maneuverable (FIGS. 1; 3) in water and/or over the seabed or a vehicle that is maneuverable (FIGS. 3; 3) in water and/or over the seabed.

The method wherein the mineral deposits to be identified and can be separated, but not limited to, manganese crusts, nodules or sulphide deposits from other matter based on electric and/or acoustic parameters (FIGS. 1; 1, 2, 4, 7, FIGS. 2; 1, 2, 4, 7).

A non-transitory memory storing a computer (FIGS. 1; 2, FIGS. 2; 2 and/or FIGS. 3; 2, FIGS. 4; 2) providing an executable program for supporting offshore mineral mining, the program causing at least one processor (FIGS. 1; 2, FIGS. 2; 2) and/or (FIGS. 3; 2, FIGS. 4; 2) to perform the steps of:
receiving data (FIGS. 1; 1, FIGS. 2; 1) and/or data (FIGS. 3; 1, FIGS. 4; 1) related to parameters of an area of interest on a seabed identifying mineral deposits; and/or
receiving data (FIGS. 1; 7, FIGS. 2; 7 and/or data FIGS. 3; 7, FIGS. 4;7) related to parameters of an area of interest on a seabed identifying mineral deposits;
   processing the data (FIGS. 1; 2, FIGS. 2; 2 and/or FIGS. 3; 2, FIGS. 4; 2) to determine locations on the seabed where economic sound concentrations of mineral deposits are identified,
   the processing utilizing signal processing, to identify the economic sound concentrations of mineral deposits based on the data signals;
   and at least one of;
a collector (FIGS. 1; 4, FIGS. 2; 4) that selectively collects the identified mineral deposits based on the identified locations determined by the processor. The collector can, comprise an at least one degree of freedom of any combinations of, a robotic arm, a trunk, a claw, a cutting device or a suction-based system and a storage unit (FIGS. 1; 8, FIGS. 2; 8) to hold the collected minerals,
a communication device (FIGS. 3; 5, FIGS. 4; 5) which is in communication with at least one external vessel (FIGS. 3; 10, FIGS. 4; 10),
at least one component (1-9) and/or feature (a-n) (FIG. 1, FIG. 2 and/or FIG. 3, FIG. 4) can be totally or partially integrated into a vehicle (10).

The system and/or the method wherein the at least one processor (FIGS. 1; 2, FIGS. 2; 2) and/or (FIGS. 3; 2, FIGS. 4; 2) can include at least one self-correcting algorithm.

The system and/or method wherein the at least one processor (FIGS. 1; 2, FIGS. 2; 2 and/or FIGS. 3; 2, FIGS. 4; 2) includes at least one Learning (ML) and/or AI algorithm to make high-level navigation and collection strategy decisions and constitute a mapping and data collection framework to maintain historical information and optimize future operations, characterized by at least one of:
Simulation System,
Mapping and Data Collection System,
Sensor Data Processing System,
DQL Navigation and Decision Agent,
Classification and Prediction System,
System Integration Architecture,
Self-Correction and Learning System,
Performance and Safety System,
Economic Optimization System,
Environmental Protection System.

The system and/or the method wherein the at least one vessel (FIG. 1, FIG. 2 and/or FIG. 3, FIG. 4) can include a power unit (6) and/or a locking device (9).

A method:
sensing, using at least one electric and/or acoustic sensor (FIGS. 1; 1, a, b, FIGS. 2; 1, a, b), parameters of an area of interest on a seabed to identify mineral deposits and generating data signals based on the sensed parameters;
processing, using at least one processor (FIGS. 1; 2, FIGS. 2; 2) the data signals and determining locations on the seabed where economically sound concentrations, determined using quantifiable thresholds of mineral deposits are identified, wherein the processor utilizes signal processing to identify the economic sound concentrations of the mineral deposits based on the data signals; and
   selectively collecting, using a collector (FIGS. 1; 4, FIGS. 1; 4), the identified mineral deposits based on the identified locations determined by the processor.”

A non-transitory memory storing a computer (FIGS. 1; 2, FIGS. 2; 2 and/or FIGS. 3; 2, FIGS. 4; 2) providing an executable program for supporting offshore mineral mining, the program causing at least one processor (FIGS. 1; 2, FIGS. 2; 2 and/or FIGS. 3; 2, FIGS. 4; 2) to perform the steps of, but not limited to, execute and/or control at least one of the following tasks, components or functionalities;
Data Collection: Gather acoustic and/or electric parameter data from an area of interest. This could include e.g. sound speed or velocity, density, acoustic impedance, and attenuation for acoustic parameters, and resistivity or conductivity for electric parameters.
Data Preprocessing:
   Filter the acoustic data to remove noise and enhance signal quality.
   Normalize electric sensor data to account for variations in sensor performance and environmental factors.
Feature Extraction: Process the collected data to extract meaningful features that can, but not limited to, differentiate between manganese crusts, nodules and/or sulphide deposits, and other matter. Features could include statistical descriptors of the signal(s), spectral content, and derived quantities like reflection coefficients.
Data Labeling: Data needs to be classified into categories (e.g., manganese crusts, nodules, sulphide deposits, other matter) based on ground truth information obtained from e.g. samples or previous surveys.
Signal Processing: Use the labeled dataset to train a supervised model such as e.g. a Convolutional Neural Network (CNN) model, which can recognize patterns in the feature set that are indicative of different materials.
Real Time Classification: Apply the trained model to new data to classify it into categories. Train the model e.g. on labeled datasets where the ground truth (manganese crusts, nodules, sulphide deposits, or other matter) is known. The model can output probabilities for each category, and the highest probability can determine the classification.
Separation Decision/Threshold: Incorporate at least a set of threshold probabilities for the model's output to decide whether the material is, but not limited to, a manganese crust, nodules or sulphide deposit of economic value or meets the at least one threshold.
Post-Processing: Apply additional rules or filters based on domain knowledge to refine the classification results. For example, geological knowledge about the distribution of these deposits can help in validating the model's output.
Verification and Self-Correction: Periodically collect samples of the separated material and analyze them to verify the accuracy of the separation process. Adjust the at least one model and threshold settings based on verification results to improve accuracy.

a) Acoustic Sensors: Could also be applied to collect high-resolution echo data from the seabed, which could also help in identifying the density and composition of the various materials.

b) Electric Sensors: To measure e.g. the electrical conductivity and/or resistivity of the seabed material, as different minerals have distinct electrical properties.

c) Processing Unit with Key Functionalities: This could be the one computer in question and/or added microcontroller that runs the at least one separation algorithm. It would take the sensor data as input and output commands to the separation mechanism (4).

d) Data Acquisition Sub-System: This sub-system would collect the data from the sensors (1, 7) and convert it into a format that can be processed. This often involves analogue-to-digital conversion, but not necessary.

e) Wavelet-Based Algorithm: Improves signal quality by reducing system interference and ambient noise. It may include a wavelet-based envelope extraction method, and an adaptive estimation strategy based on dual-channel information.

f) Wavelet Regression: Can be applied to reduce measuring noise, assuming that the crusts have local thickness invariability. This is particularly useful for crusts with a structure of multilayers at the top surface and a single layer at the bottom surface.

g) User Interface: This would allow the user to start and stop the process, adjust parameters, and monitor the system's status. The user can be located top-side (manned or un-manned surface vessel) and/or be a submerged manned or un-manned machine and/or a vehicle (10).

### 11. CONCLUSION

The present invention introduces a novel, inventive and technically robust approach to offshore mineral mining that addresses longstanding challenges of inefficiency, environmental impact, and economic uncertainty inherent in current extraction methods. By leveraging measurable differences in acoustic and electric properties between valuable mineral deposits and non-valuable seabed material, the invention enables selective, intelligent, and economically sound harvesting operations.

The invention departs significantly from prior art by combining the following:
Advanced sensor systems capable of real-time, in-situ material differentiation,
Intelligent control systems that can incorporate ML/AI, adaptive thresholding, and real-time decision-making,
Mechanical architectures that allow precise and selective collection based on sensor input,
A comprehensive economic model that defines dynamic profitability thresholds tailored to local and temporal conditions.

These components form a cohesive, integrated system that can function autonomously or as an enhancement to existing offshore mineral extraction platforms. The solution enables optimized resource recovery, minimizes unnecessary material handling, reduces energy consumption, and supports responsible environmental stewardship, all while improving economic returns.

Furthermore, the system architecture is inherently modular, making it adaptable to various mineral types (e.g., manganese crusts, nodules, sulphide deposits) and deployable across a broad range of oceanic and geological conditions. The incorporation of real-time data processing, predictive models, and potential for self-learning capabilities ensures operational resilience and long-term adaptability in a rapidly evolving technological and geopolitical landscape.

The invention demonstrates a clear inventive step over prior art through its combination of physical mineral discrimination, profit-driven decision logic, and autonomous execution. It provides a practical, scientifically substantiated, and commercially viable solution to a pressing global challenge, the sustainable and economically feasible extraction of critical seabed minerals.

Accordingly, the systems, methods, and components described herein represent a significant advancement in the field of offshore mineral resource utilization and lay a foundation for future intelligent deep-sea mining operations.

### APPENDIX

Detailed assessment of primary components and steps within a suggested ML/AI system related to:

### 6.2.1.1 Development of ML/AI Components to Fulfill the Requirements for “Systems for Optimal Offshore Mineral Mining”—if Applied

### 1. Simulation Environment

A comprehensive simulation environment is required to develop and validate the AI systems before real-world deployment. This environment serves multiple purposes: training the DQL navigation agent, testing sensor processing algorithms, and generating synthetic training data for the classification systems. The simulation must accurately model the complex dynamics of deep-sea operations while remaining computationally efficient enough for rapid training iterations.

### 1.1 Physics Modeling

The simulation incorporates key physical aspects of the deep-sea environment:
Seabed terrain generation using procedural methods with configurable parameters for different geological formations
Water dynamics including currents, pressure variations, and turbulence
Physical interactions between collection mechanisms and seabed materials
Vehicle dynamics modeling accounting for buoyancy, drag, and thrust
Energy consumption models for different operations (movement, scanning, collection)

### 1.2 Sensor Response Simulation

Accurate modeling of sensor responses is crucial for developing robust detection algorithms:
Acoustic sensor simulation incorporating:
   Sound propagation in water
   Material-specific acoustic properties (as specified in section 5.2)
   Noise and interference patterns
   Resolution degradation with distance
Electrical sensor simulation including:
   Conductivity and resistivity responses
   Environmental interference
   Sensor range limitations
   Signal attenuation through different materials

### 1.3 Environmental Variations

The simulation includes dynamic environmental conditions to ensure system robustness:
Water current patterns at different depths
Visibility variations affecting sensor performance
Temperature gradients and their effect on sensor readings
Seabed composition variations
Seasonal and weather-related changes

### 1.4 Mineral Deposit Scenarios

A variety of test scenarios are implemented to validate system performance:
Different types of mineral deposits (manganese crusts, nodules, sulphide deposits)
Varying concentrations and distributions
Mixed deposits with different economic values
Challenging scenarios with partial sensor occlusion
Edge cases for system testing

### 1.5 Training Data Generation

The simulation environment serves as a primary source of synthetic training data, generating extensive datasets for training both the sensory prediction systems and the DQL agent:

### 1.5.1 Large-Scale Synthetic Dataset Creation

Automated generation of diverse scenarios:
   Random placement of mineral deposits with varying compositions
   Random sampling positions and orientations
   Multiple sensor readings from different distances and angles
   Generation of thousands of unique configurations
Synthetic sensor response generation:
   Simulated acoustic and electrical readings for each scenario
   Multiple readings per position to account for noise
   Varying environmental conditions for each reading

### 1.5.2 Data Augmentation and Variation

Introduction of realistic noise patterns
Simulation of sensor degradation and malfunction
Environmental interference patterns
Partial occlusion scenarios
Different seabed topology configurations

### 1.5.3 Ground Truth Labeling.

Automatic annotation of:
   Mineral type and composition
   Deposit size and distribution
   Economic value calculations
   Environmental sensitivity metrics
   Optimal collection strategies

### 1.5.4 Validation Framework

Separate validation scenarios
Performance benchmarks
Edge case testing
System stress testing
Cross-validation datasets

This comprehensive data generation system ensures that the AI components have sufficient training data to develop robust and accurate prediction capabilities before real-world deployment, while the validation framework provides quantitative metrics for system performance assessment.

### 2. Mapping & Data Collection System

The mapping and data collection system serves as the foundational layer for all other AI components, maintaining a comprehensive understanding of the operational environment and historical data. This system continuously updates a 3D representation of the seabed while storing and organizing all sensor readings and operational outcomes.

### 2.1 Real-Time 3D Mapping

Dynamic map generation and updating:
   High-resolution bathymetric data
   Integration of multiple sensor inputs
   Real-time topography updates
   Obstacle and hazard identification
   Confidence metrics for map accuracy

### 2.2 Data Storage and Organization

Hierarchical data structure for efficient access:
   Raw sensor readings (acoustic and electrical)
   Processed sensor data
   Mineral classification results
   Collection operation outcomes
   Environmental impact assessments
Time-stamped historical records
Spatial indexing for quick retrieval
Compression strategies for long-term storage

### 2.3 Mineral Deposit Tracking

Continuous updating of identified deposits:
   Location and extent
   Composition predictions
   Confidence levels
   Economic value estimates
   Collection status
Historical mining activity records
Success/failure outcome logging

### 2.4 Environmental Monitoring

Tracking of seabed disturbance
Cumulative impact assessment
Recovery monitoring of previously mined areas
Identification of sensitive areas
Long-term change detection
   2.5 Integration with Decision Systems
State space representation for DQL agent:
   Local area characteristics
   Global position context
   Historical performance data
   Resource availability
Performance feedback loops:
   Prediction accuracy tracking
   Collection success rates
   Economic outcome validation
   Environmental impact verification

This system not only maintains the operational knowledge base but also provides crucial input for the DQL agent's decision-making process and enables continuous improvement of the prediction systems through comprehensive performance tracking.

### 3. Sensor Data Processing

The sensor data processing system handles the raw acoustic and electrical sensor inputs, processes them to extract meaningful features, and evolves over time through the incorporation of deep learning models trained on operational data. This hybrid approach ensures reliable baseline performance while enabling continuous improvement through learning.

### 3.1 Traditional Signal Processing Pipeline

Initial data cleaning:
   Noise filtering
   Signal normalization
   Outlier detection
   Missing data handling
Feature extraction:
   Wavelet-based decomposition
   Frequency domain analysis
   Statistical features
   Signal correlation metrics
Baseline classification rules:
   Threshold-based detection
   Pattern matching
   Signal characteristic analysis

### 3.2 Deep Learning Enhancement

Multi-modal neural network architecture:
   Acoustic signal processing branch
   Electrical signal processing branch
   Feature fusion layers
   Classification/prediction outputs
Training methodology:
   Initial training on simulation data
   Fine-tuning with real operational data
   Continuous learning from new observations
   Validation against traditional methods

### 3.3 Sensor Fusion

Integration of multiple sensor types:
   Acoustic sensor arrays
   Electrical conductivity sensors
   Environmental sensor data.
Multi-scale analysis:
   Broad area scanning
   Detailed local inspection
   Cross-validation between sensors
Confidence scoring system

### 3.4 Performance Monitoring

Real-time quality assessment:
   Signal quality metrics
   Prediction confidence scores
   Cross-validation results
Adaptive processing:
   Environmental condition compensation
   Sensor degradation correction
   Dynamic noise filtering
Performance optimization:
   Processing speed vs accuracy trade-offs
   Resource usage optimization
   Real-time requirements compliance

### 3.5 Integration Points

Input to Classification System:
   Processed sensor features
   Confidence metrics
   Environmental context
Input to DQL Agent:
   Current sensor status
   Processing results
   Quality metrics
Feedback mechanisms:
   Performance logging
   Error correction
   Model updating

### 4. DQL Navigation & Decision Agent

The Deep Q-Learning Navigation and Decision Agent serves as the primary decision-maker for the system, optimizing exploration, scanning, and collection strategies to maximize economic return while minimizing environmental impact. This agent operates continuously in a complex state space, making both strategic and tactical decisions about system operation.

### 4.1 State Space Definition

The agent operates in a rich state space encompassing:
Position Information:
   Current 3D coordinates and orientation
   Velocity and acceleration
   Distance to known deposits
   Distance to unexplored areas
Resource Status:
   Current energy levels
   Energy consumption rate
   Storage capacity remaining
   Expected operation time
Environmental Data:
   Local scan data from sensors
   Seabed topology
   Environmental sensitivity metrics
   Current conditions (currents, visibility)
Historical Context:
   Map data of explored areas
   Previous collection successes/failures
   Known deposit distributions
   Area economic performance history
Economic Parameters:
   Current mineral value thresholds
   Operating cost metrics
   Collection efficiency metrics
   Risk assessment scores

### 4.2 Action Space

The agent can execute multiple types of actions:
Navigation Actions:
   3D movement commands
   Speed and direction control
   Depth adjustments
   Station-keeping
Scanning Operations:
   Scan resolution selection
   Sensor type selection
   Area coverage patterns
   Detailed inspection triggers
Collection Decisions:
   Initiate/abort collection
   Collection method selection
   Collection intensity control
   Storage management

### 4.3 Reward Function Design

The reward function balances multiple objectives:
Economic Components:
   Mineral value collected
   Operating costs (energy, time)
   Equipment wear
   Transportation costs
Environmental Factors:
   Seabed disruption metrics
   Ecosystem impact scores
   Recovery time estimates
   Cumulative impact assessment
Exploration Value:
   New area discovery bonus
   Information gain metrics
   Uncertainty reduction value
   Pattern recognition rewards

### 4.4 Training and Optimization

Multi-stage Training Process:
   Initial simulation training
   Supervised learning from expert demonstrations
   Real-world fine-tuning
   Continuous learning during operation
Safety Constraints:
   Action space limitations
   Risk-aware exploration
   Emergency protocol integration
   Environmental protection rules

### 4.5 Performance Monitoring

Real-time Metrics:
   Decision quality assessment
   Economic performance tracking
   Environmental impact monitoring
   Exploration efficiency metrics
Adaptation Mechanisms:
   Policy updates based on outcomes
   Dynamic threshold adjustment
   Learning rate optimization
   Exploration strategy adaptation

### 5. Classification & Prediction System

The Classification & Prediction System processes the sensor data to identify mineral deposits, predict their quantities, and estimate their economic value. This system employs a combination of machine learning models working together to provide accurate predictions with associated confidence metrics.

### 5.1 Mineral Classification

Multi-class Classification System:
   Mineral type identification
   Composition analysis
   Purity assessment
   Deposit structure classification
Feature Processing:
   Acoustic signature analysis
   Electrical conductivity patterns
   Multi-sensor data fusion
   Contextual feature extraction.
Classification Models:
   Primary deep learning classifier
   Ensemble of specialized models
   Traditional backup classifiers
   Real-time model selection

### 5.2 Quantity Prediction

Deposit Size Estimation:
   Volume calculation
   Density prediction
   Distribution mapping
   Continuity assessment
Resource Modeling:
   3D deposit modeling
   Concentration gradients
   Structural analysis
   Geological context integration
Prediction Updates:
   Real-time refinement
   Multi-scale analysis
   Historical pattern matching
   Error correction

### 5.3 Economic Value Estimation

Value Calculation:
   Current market prices
   Extraction difficulty factors
   Processing requirements
   Transportation costs
Risk Assessment:
   Quality uncertainty
   Extraction challenges
   Environmental considerations
   Operational risks
ROI Prediction:
   Cost-benefit analysis
   Operation time estimation
   Resource requirement calculation
   Value optimization strategies

### 5.4 Uncertainty Quantification

Probabilistic Modeling:
   Confidence intervals
   Error bounds
   Variance estimation
   Risk quantification
Multi-source Validation:
   Cross-sensor verification
   Historical data comparison
   Model ensemble agreement
   Environmental factor impact

### 5.5 Confidence Scoring

Comprehensive Scoring System:
   Classification confidence
   Quantity prediction reliability
   Value estimation accuracy
   Environmental impact certainty
Decision Support:
   Confidence thresholds
   Risk-aware decision making
   Uncertainty-based planning
   Resource allocation optimization
Performance Tracking:
   Prediction accuracy monitoring
   Error pattern analysis
   Model calibration metrics
   Continuous improvement feedback

### 5.6 Integration and Updates

System Integration:
   Real-time data pipeline
   DQL agent feedback
   Mapping system updates
   Operation planning input
Model Updates:
   Online learning implementation
   Performance-based adaptation
   New pattern incorporation
   Concept drift handling

### 6. System Integration Architecture

The integration architecture ensures seamless operation between all AI components and physical systems, providing robust, real-time performance while maintaining safety and reliability.

### 6.1 Data Flow Architecture

Real-time Processing Pipeline:
   Sensor data ingestion and distribution
   Priority-based processing queues
   Real-time performance monitoring
   Load balancing and scaling
Inter-system Communication:
   Message passing protocols
   Data serialization standards
   State synchronization
   Event handling system
Storage Architecture:
   Real-time operational data
   Historical data management
   Model storage and versioning
   Performance metrics logging

### 6.2 Hardware Integration

Sensor Systems Interface:
   Raw data acquisition
   Calibration management
   Error detection
   Health monitoring
Collection Mechanism Control:
   Command translation
   Feedback processing
   Safety constraint enforcement
   Emergency override systems
Physical System Monitoring:
   Component status tracking
   Performance metrics
   Maintenance predictions
   Failure detection

### 6.3 Operational Control Flow

Decision Execution Pipeline:
   DQL agent command processing
   Safety validation
   Resource allocation
   Action coordination
Error Handling:
   Fault detection
   Graceful degradation
   Recovery procedures
   Backup systems activation
Performance Optimization:
   Resource utilization monitoring
   Processing latency management
   System capacity optimization
   Quality of service maintenance

### 7. Self-Correction & Learning

The self-correction and learning systems enable continuous improvement of all AI components through operational experience, ensuring optimal performance and reliability over time.

### 7.1 Continuous Learning Framework

Model Update System:
   Performance monitoring
   Training data collection
   Model retraining triggers
   Validation procedures
Adaptation Mechanisms:
   Parameter adjustment
   Feature importance updates
   Decision threshold optimization
   Policy refinement

### 7.2 Error Detection and Correction

Performance Monitoring:
   Prediction accuracy tracking
   Decision quality assessment
   Resource efficiency metrics
   Environmental impact monitoring
Error Response:
   Root cause analysis
   Correction strategy selection
   Implementation verification
   Impact assessment

### 7.3 Knowledge Integration

Experience Collection:
   Successful operation patterns
   Failure case documentation
   Environmental condition effects
   Economic outcome correlation
System Updates:
   Model retraining
   Policy updates
   Parameter optimization
   Rule refinement

### 7.4 Safety and Reliability

Performance Boundaries:
   Operating limits definition
   Risk assessment
   Safety constraint enforcement
   Emergency response triggers
Validation Framework:
   Update Verification
   Performance regression testing
   Safety compliance checking
   Reliability assessment

### 7.5 Long-Term Optimization

Strategic Improvement:
   Performance trend analysis
   Resource optimization
   Cost efficiency enhancement
   Environmental impact reduction
System Evolution:
   Capability expansion
   Algorithm refinement
   Feature enhancement
   Integration optimization

### 8. Performance & Safety Systems

This system provides comprehensive monitoring, evaluation, and safety mechanisms, ensuring reliable operation while maintaining clear performance metrics and robust fallback procedures.

### 8.1 Performance Metrics Framework

Economic Performance:
   Cost per unit mineral collected
   Energy efficiency metrics
   Time-to-collection ratios
   ROI calculations
   Operation optimization scores
Environmental Monitoring:
   Seabed disruption measurements
   Area impact assessments
   Recovery time predictions
   Cumulative effect tracking
Prediction Performance:
   Classification accuracy
   Quantity estimation error rates
   Value prediction accuracy
   Confidence score reliability
System Health Metrics:
   Component status tracking
   Performance degradation detection
   Resource utilization monitoring
   Operation efficiency scores

### 8.2 Fallback Systems

Traditional Algorithmic Backups:
   Rule-based navigation systems
   Basic mineral detection algorithms
   Simple collection strategies
   Manual control capabilities
Graceful Degradation:
   Performance level transitions
   Functionality prioritization
   Resource reallocation
   Minimal operation modes

### 8.3 Emergency Response System

Emergency Protocols:
   System shutdown procedures
   Safe state transitions
   Resource conservation modes
   Communication fallbacks.
Crisis Management:
   Damage mitigation procedures
   Recovery protocols
   Resource preservation
   Environmental protection measures

### 8.4 Fault Tolerance Architecture

Redundancy Systems:
   Component redundancy
   Data backup mechanisms
   Processing failover
   Communication redundancy
Error Handling:
   Fault detection algorithms
   Error containment strategies
   Recovery procedures
   System restoration protocols

### 8.5 Safety Enforcement

Operational Boundaries:
   Movement restrictions
   Collection limits
   Environmental thresholds
   Resource constraints
Safety Protocols:
   Collision avoidance
   Environmental protection rules
   Equipment protection
   Emergency responses
Compliance Monitoring:
   Regulatory requirement tracking
   Safety standard adherence
   Environmental compliance
   Performance standard maintenance

### 8.6 System Validation

Regular Testing:
   Component testing
   Integration testing
   Performance validation
   Safety system verification
Documentation:
   Performance reports
   Incident logging
   Improvement tracking
   Compliance documentation

### 9. Economic Optimization Systems

This section details the economic decision-making capabilities of the AI system, providing comprehensive specifications for market adaptation, cost optimization, and value maximization strategies.

### 9.1 Market Intelligence System

### 9.1.1 Real-Time Market Data Integration

Commodity Price Monitoring:
   Direct feeds from major mineral exchanges
   Historical price pattern analysis
   Forward contract pricing
   Spot market tracking
   Price volatility assessment.
Global Market Analysis:
   Supply-demand equilibrium tracking
   Regional market differentials
   Currency exchange impact
   Transportation cost indices
   Competitive activity monitoring

### 9.1.2 Predictive Market Modeling

Short-term Price Predictions:
   24-hour price movement forecasting
   Weekly trend analysis
   Volatility prediction
   Market sentiment integration
   Risk factor assessment
Long-term Market Trends:
   Seasonal pattern recognition
   Multi-year cycle analysis
   Technology impact assessment
   Regulatory change predictions
   Industry development tracking

### 9.2 Operational Cost Optimization

### 9.2.1 Dynamic Cost Modeling

Direct Operational Costs:
   Energy consumption per ton
   Equipment wear rates
   Maintenance scheduling
   Labor cost optimization
   Consumables usage tracking
Indirect Cost Factors:
   Weather impact assessment
   Depth-based cost variations
   Equipment efficiency decay
   Support service optimization
   Insurance cost management

### 9.2.2 Resource Allocation Optimization

Equipment Utilization:
   Operating hours optimization
   Maintenance timing
   Capacity utilization rates
   Performance degradation tracking
   Replacement timing optimization
Personnel Resource Management:
   Shift optimization
   Skill requirement planning
   Training need prediction
   Safety cost assessment
   Productivity optimization

### 9.3 Value Maximization Framework

### 9.3.1 Grade-Based Optimization

Mineral Grade Assessment:
   Real-time grade analysis
   Grade distribution mapping
   Processing requirement assessment
   Recovery rate optimization
   Blend optimization strategies
Value-based Selection:
   Grade cutoff optimization
   Processing method selection
   Recovery method optimization
   Storage strategy optimization
   Transport timing optimization

### 9.3.2 Collection Strategy Optimization

Collection Planning:
   Optimal collection sequence
   Equipment selection logic
   Collection rate optimization
   Storage capacity management
   Processing queue optimization
Operational Timing:
   Market-based timing strategies
   Weather window optimization
   Equipment availability matching
   Resource availability alignment
   Maintenance schedule integration

### 9.4 DQL Agent Economic Integration

### 9.4.1 Economic State Space

Market Conditions:
   Current prices and trends
   Market volatility indicators
   Supply-demand metrics
   Competition indicators
   Future price predictions
Operational Status:
   Current costs and efficiency
   Resource quality metrics
   Equipment status
   Personnel availability
   Storage capacity status

### 9.4.2 Economic Action Space

Collection Decisions:
   Target selection criteria
   Collection intensity control
   Equipment configuration
   Processing method selection
   Storage allocation
Timing Optimization:
   Operation scheduling
   Market timing strategies
   Maintenance planning
   Resource allocation timing
   Transport coordination

### 9.5 Adaptive Economic Strategy System

### 9.5.1 Short-Term Optimization

Real-time Adjustments:
   Collection rate modification
   Grade cutoff adaptation
   Equipment utilization adjustment
   Resource reallocation
   Cost control measures
Daily Operations:
   Shift planning optimization
   Equipment deployment
   Maintenance scheduling
   Resource utilization
   Performance monitoring

### 9.5.2 Long-Term Strategy

Strategic Planning:
   Equipment lifecycle management
   Technology upgrade planning
   Market position optimization
   Resource development planning
   Capability enhancement
Risk Management:
   Market risk assessment
   Operational risk evaluation
   Technology risk management
   Regulatory compliance planning
   Environmental risk consideration

### 9.6 Performance Metrics and Reporting

### 9.6.1 Economic Performance Metrics

Financial Metrics:
   Return on investment (ROI)
   Operating margin analysis
   Cost per ton metrics
   Revenue optimization
   Profit maximization
Operational Metrics:
   Equipment efficiency
   Resource utilization
   Processing effectiveness
   Collection rate optimization
   Quality management

### 9.6.2 Reporting and Analysis

Performance Reporting:
   Real-time dashboards
   Trend analysis
   Variance reporting
   Predictive analytics
   Strategic recommendations
Continuous Improvement:
   Performance optimization
   Cost reduction initiatives
   Efficiency improvements
   Process optimization
   Technology integration

This comprehensive economic framework ensures optimal financial performance through sophisticated market intelligence, cost optimization, and value maximization strategies. The system's adaptive nature allows for dynamic response to changing market conditions while maintaining operational efficiency.

### 10. Environmental Protection Systems

This section details the environmental protection mechanisms of the AI system, providing comprehensive specifications for impact assessment, prevention, monitoring, and ecosystem preservation strategies.

### 10.1 Environmental Impact Assessment

### 10.1.1 Physical Impact Monitoring

Seabed Disturbance Metrics:
   Topographical change measurement (±0.1 mm precision)
   Sediment dispersion tracking (particle size 1-1000 μm)
   Substrate composition analysis
   Structural integrity assessment
   Recovery rate monitoring
Water Column Effects:
   Turbidity measurement (0-1000 NTU range)
   Chemical composition analysis
   Temperature variation (±0.1° C. precision)
   Current pattern disruption
   Sediment plume tracking

### 10.1.2 Ecosystem Impact Assessment

Biodiversity Monitoring:
   Species population tracking
   Habitat distribution mapping
   Community structure analysis
   Behavioral pattern monitoring
   Migration pattern tracking
Ecosystem Health Indicators:
   Primary productivity measurement
   Food web interaction analysis
   Species diversity indices
   Population density tracking
   Ecosystem resilience assessment

### 10.2 Preventive Protection Framework

### 10.2.1 Pre-Operation Assessment

Habitat Mapping:
   High-resolution 3D mapping
   Sensitive area identification
   Species distribution analysis
   Ecological corridor mapping
   Seasonal variation assessment
Risk Assessment:
   Vulnerability analysis
   Impact prediction modeling
   Recovery potential evaluation
   Cumulative effect assessment
   Mitigation strategy development

### 10.2.2 Operational Controls

Activity Limitations:
   Speed restrictions
   Collection depth control
   Equipment pressure limits
   Noise level management
   Vibration control
Protection Zones:
   Dynamic exclusion areas
   Buffer zone management
   Seasonal restriction zones
   Recovery area protection
   Migration corridor preservation

### 10.3 Real-Time Monitoring Systems

### 10.3.1 Continuous Environmental Monitoring

Physical Parameters:
   Temperature profiles
   Pressure variations
   Current measurements
   Turbidity monitoring
   Chemical composition
Biological Indicators:
   Species presence detection
   Behavioral monitoring
   Population movement tracking
   Interaction pattern analysis
   Stress response indicators

### 10.3.2 Adaptive Response System

Threshold Management:
   Impact limit monitoring
   Warning level triggers
   Emergency shutdown criteria
   Recovery period requirements
   Cumulative impact limits
Response Actions:
   Activity modification protocols
   Equipment adjustment procedures
   Operation suspension criteria
   Alternative method selection
   Impact mitigation measures

### 10.4 AI-Driven Protection Mechanisms

### 10.4.1 Neural Network Environmental Analysis

Pattern Recognition:
   Ecosystem change detection
   Behavior pattern analysis
   Impact progression tracking
   Recovery trend identification
   Risk pattern recognition
Predictive Modeling:
   Impact prediction
   Recovery time estimation
   Risk level assessment
   Cumulative effect projection
   Mitigation effectiveness prediction

### 10.4.2 Protective Decision Making

Operation Modification:
   Collection method adaptation
   Route optimization
   Timing adjustment
   Equipment configuration
   Resource selection
Impact Minimization:
   Sediment control strategies
   Noise reduction methods
   Vibration dampening
   Chemical exposure limitation
   Habitat preservation techniques

### 10.5 Recovery Management System

### 10.5.1 Post-Operation Monitoring

Recovery Tracking:
   Seabed regeneration monitoring
   Species recolonization assessment
   Ecosystem function recovery
   Habitat restoration progress
   Water quality normalization
Impact Assessment:
   Long-term effect monitoring
   Recovery rate analysis
   Ecosystem stability evaluation
   Biodiversity recovery tracking
   Function restoration assessment

### 10.5.2 Adaptive Management

Recovery Support:
   Natural recovery promotion
   Assisted recovery methods
   Habitat enhancement strategies
   Species support measures
   Ecosystem stabilization techniques
Long-term Planning:
   Recovery goal setting
   Progress monitoring systems
   Intervention timing optimization
   Resource allocation planning
   Stakeholder engagement

### 10.6 Integration and Reporting

### 10.6.1 Environmental Performance Metrics

Impact Metrics:
   Disturbance quantification
   Recovery rate measurement
   Biodiversity indices
   Ecosystem health scores
   Cumulative impact assessment
Performance Indicators:
   Protection effectiveness
   Recovery success rates
   Mitigation efficiency
   Compliance levels
   Sustainability scores

### 10.6.2 Documentation and Reporting

Compliance Documentation:
   Regulatory requirement tracking
   Performance standard verification
   Impact assessment reports
   Mitigation effectiveness
   Recovery progress documentation
Stakeholder Communication:
   Performance dashboards
   Progress reports
   Impact assessments
   Recovery updates
   Compliance verification

This comprehensive environmental protection framework ensures responsible resource extraction while maintaining ecosystem integrity through sophisticated monitoring, protection, and recovery systems. The integration of AI-driven decision making enables proactive environmental protection and effective impact mitigation.

1. A system for offshore mineral mining, comprising:
at least one electric and/or acoustic sensor (FIGS. 1; 1 a, b, FIGS. 2; 1, a, b) wherein mineral deposits can be identified and can be separated, but not limited to, manganese crusts, nodules or sulphide deposits from other matter based on electric and/or acoustic parameters (FIGS. 1; 1, 2, 4, FIGS. 2; 1, 2, 4),
wherein the at least one electric and/or acoustic sensor (FIGS. 1; 1, a, b, FIGS. 2; 1, a, b) can measure at least one of, but are not limited to, electric conductivity, resistivity, dielectric properties, centroid frequency, ultrasonic characteristics, sounds, velocities, density, acoustic impedance, attenuation, of seabed material to identify mineral deposits, and generates data signals based on the sensed parameters;
at least one processor (FIGS. 1; 2, FIGS. 2; 2) that processes the signals, wherein the processor utilizes signal processing to identify the economic sound concentrations of the mineral deposits based on the data signals;
and at least one of;
a collector (FIGS. 1; 4, FIGS. 2; 4) that selectively collects the identified mineral deposits based on the identified locations determined by the processor. The collector can, comprise an at least one degree of freedom of any combinations of, a robotic arm, a trunk, a claw, a cutting device or a suction-based system and a storage unit (FIGS. 1; 8, FIGS. 2; 8) to hold the collected minerals,
a communication device (FIGS. 3; 5, FIGS. 4; 5) which is in communication with at least one external vessel (FIGS. 3; 10, FIGS. 4; 10),
at least one component (1-9) and/or feature (a-n) (FIG. 1, FIG. 2 and/or FIG. 3, FIG. 4) can be totally or partially integrated into a vehicle (10).

2. The system of claim 1, wherein the at least one sensor (FIGS. 1; 7, FIGS. 2; 7 and/or FIGS. 3; 7, FIG. 4; 7) includes an acoustic sensor that senses echo data from the seabed to identify the mineral deposits.

3. The system of claim 1, further comprising a vehicle that is maneuverable (FIGS. 1; 3) in water and/or over the seabed or a vehicle that is maneuverable (FIGS. 3; 3) in water and/or over the seabed.

4. The system of claim 3 wherein the vehicle (FIG. 1) includes a storage unit (FIGS. 1; 8) that holds the mineral deposits collected by the collector (FIGS. 1; 4, FIGS. 2; 4).

5. The system of claim 3, wherein a vehicle (FIG. 1) include(s) a communication device (FIGS. 1; 5, FIGS. 2; 5) and/or a vehicle (FIG. 3) include(s) a communication device (FIGS. 3; 5, FIGS. 4; 5) configured to transmit and receive information with a master control station and/or at least one external vessel (FIGS. 3; 10, FIGS. 4; 10).

6. The system of claim 3, wherein a vehicle (FIG. 1) include(s) at least one environmental monitoring sensor (FIGS. 1; 7) to ensure compliance with regulations and to minimize environmental impact by the collector (FIGS. 1; 4, FIGS. 2; 4).

7. The system of claim 1, wherein a separator (FIGS. 1; 4, FIGS. 2; 4), based on output data from the at least one processor (2), that separates and/or collects the identified mineral deposits from other matter that is identified on the seabed to differentiate and/or collect the identified mineral deposits from the other matter, wherein the separator is operated by the processor (FIG. 1; 2, FIGS. 2; 2) to differentiate and/or collect the identified economically sound concentrations of mineral deposits from other matter.

8. The system of claim 1, wherein the at least one processor (FIGS. 1; 2, FIGS. 2; 2 and/or FIGS. 3; 2, FIGS. 4; 2) includes at least one self-correcting algorithm.

9. The system of claim 1, wherein the at least one processor (FIGS. 1; 2, FIGS. 2; 2 and/or FIGS. 3; 2, FIGS. 4; 2) includes at least one Learning (ML) and/or AI algorithm to make high-level navigation and collection strategy decisions and constitute a mapping and data collection framework to maintain historical information and optimize future operations, characterized by at least one of:
Simulation System,
Mapping and Data Collection System,
Sensor Data Processing System,
DQL Navigation and Decision Agent,
Classification and Prediction System,
System Integration Architecture,
Self-Correction and Learning System,
Performance and Safety System,
Economic Optimization System,
Environmental Protection System.

10. The system claim 1, wherein the at least one vessel (FIG. 1, FIG. 2 and/or FIG. 3, FIG. 4) can include a power unit (6) and/or a locking device (9).

11. A method for offshore mineral mining, comprising:
sensing, using at least one electric and/or acoustic sensor (FIGS. 1; 1, a, b, FIGS. 2; 1, a, b), parameters of an area of interest on a seabed to identify mineral deposits and generating data signals based on the sensed parameters;
processing, using at least one processor (FIGS. 1; 2, FIGS. 2; 2) the data signals and determining locations on the seabed where economically sound concentrations, determined using quantifiable thresholds of mineral deposits are identified, wherein the processor utilizes signal processing to identify the economic sound concentrations of the mineral deposits based on the data signals;
and at least one of;
selectively collecting, using a collector (FIGS. 1; 4, FIGS. 1; 4), the identified mineral deposits based on the identified locations determined by the processor,
a communication device (FIGS. 3; 5, FIGS. 4; 5) which is in communication with at least one external vessel (FIG. 3, 10, FIG. 4, 10),
at least one component (1-9) and/or feature (a-n) (FIG. 1, FIG. 2 and/or FIG. 3, FIG. 4) can be totally or partially integrated into a vehicle (10).

12. A non-transitory memory storing an executable program for supporting offshore mineral mining, the program causing at least one processor of a computer (FIGS. 1; 2, FIGS. 2; 2 and/or FIGS. 3; 2, FIGS. 4; 2) to perform the steps of:
receiving data signals (FIGS. 1; 1, FIGS. 2; 1 and/or FIGS. 3; 1, FIGS. 4; 1 and/or FIGS. 1; 7, FIG. 2; 7 and/or FIGS. 3; 7, FIGS. 4;7) generated by at least one electric and/or acoustic sensor (FIGS. 1; 1 a, b, FIGS. 2; 1, a, b) and related to parameters of an area of interest on a seabed identifying mineral deposits;
processing the data (FIGS. 1; 2, FIGS. 2; 2 and/or FIGS. 3; 2, FIGS. 4; 2) to determine locations on the seabed where economic sound concentrations of mineral deposits are identified,
the processing utilizing signal processing, to identify the economic sound concentrations of mineral deposits based on the data signals;
and at least one of;
instructing a collector (FIGS. 1; 4, FIGS. 1; 4) to selectively collect the identified mineral deposits based on the identified locations determined by the processor,
a communication device (FIGS. 3; 5, FIGS. 4; 5) which is in communication with at least one user and/or external vessel (FIG. 3, 10, FIG. 4, 10),
at least one component (1-9) and/or feature (a-n) (FIG. 1, FIG. 2 and/or FIG. 3, FIG. 4) can be totally or partially integrated into a vehicle (10).

13. The non-transitory memory storing an executable program for supporting offshore mineral mining of claim 12, the executable program further causing the at least one processor (FIGS. 1; 2, FIGS. 2; 2) to execute and/or control at least one of the following tasks, components or functionalities;
Data Collection: Gather acoustic and/or electric parameter data from the area of interest,
Data Preprocessing:
Filter the acoustic data to remove noise and enhance signal quality,
Normalize electric sensor data to account for variations in sensor performance and environmental factors,
Feature Extraction: Process the collected data to extract meaningful features that can, but not limited to, differentiate between manganese crusts, nodules and/or sulphide deposits, and other matter. Features could include statistical descriptors of the signal(s), spectral content, and derived quantities like reflection coefficients,
Data Labeling: Data to be classified into categories (e.g., manganese crusts, nodules, sulphide deposits, other matter) based on ground truth information obtained from e.g. samples or previous surveys,
Signal Processing: Use the labeled dataset to train a supervised model, e.g. a Convolutional Neural Network (CNN) model, which can recognize patterns in the feature set that are indicative of different materials,
Real Time Classification: Apply the trained model to new data to classify it into one of the categories. Train the model e.g. on labeled datasets where the ground truth (manganese crusts, nodules, sulphide deposits, or other matter) is known. The model will output probabilities for each category, and the highest probability can determine the classification,
Separation Decision/Threshold: Incorporate at least, but not limited to, a set of threshold probabilities for the model's output to decide whether the material is a manganese crust, nodules or sulphide deposit of economic value or meets the at least one threshold,
Post-Processing: Apply additional rules or filters based on domain knowledge to refine the classification results, e.g. geological knowledge about the distribution of these deposits can help in validating the model's output,
Verification and Self-Correction: Periodically collect samples of the separated material and analyze them to verify the accuracy of the separation process. Adjust the at least one model and threshold settings based on verification results to improve accuracy,
Acoustic Sensors,
Electric Sensors,
A processing Unit with Key Functionalities to run at least one separation algorithm,
A data Acquisition Sub-System to convert collected data from the sensors and convert them into processable formats,
A wavelet-Based Algorithm,
Wavelet Regression, and
User Interface.
